(19) United States
(12) Patent Application Publication
(10) Pub. No.: US 2013/0124536 A1
(43) Pub. Date: May 16, 2013

(54) INFORMATION PROCESSING APPARATUS, INFORMATION PROCESSING METHOD, AND PROGRAM

(71) Applicant: SONY CORPORATION, Tokyo (JP)

(72) Inventors: Masanori Miyahara, Tokyo (JP); Naoki Kamimaeda, Kanagawa (JP)

(73) Assignee: SONY CORPORATION, Tokyo (JP)

(21) Appl. No.: 13/669,709

(22) Filed: Nov. 6, 2012

(30) Foreign Application Priority Data
Nov. 14, 2011 (JP) 2011-248604

(51) Int. Cl. G06F 17/30

(52) U.S. Cl. 707/748; 707/758; 707/736; 707/756; 707/E17.005

(57) ABSTRACT

There is provided an information processing apparatus including a difference applying unit that obtains, according to difference feature information indicating a difference between first feature information characterizing an action of a target user and second feature information characterizing another action performed by the target user after the foregoing action is performed and third feature information characterizing an action newly performed by the target user, fourth feature information; and a target extracting unit that extracts information based on the fourth feature information.

### BACKGROUND

The present technology relates to an information processing apparatus, an information processing method, and a program.

In recent years, the development of a system for searching for content to be recommended to users using an action history such as a content view history, a content purchase history, or the like has actively progressed. For example, a structure (content-based filtering) is known in which, from meta data given to content that is the target of an action, feature vectors indicating the features of the content are generated and content to be recommended are extracted based on the similarity of the feature vectors. The structure is used in a system for recommending content of which the feature is similar to that of content selected by the user in the past. For example, Japanese Unexamined Patent Application Publication No. 2002-215665 discloses the content-based filtering.

When this content-based filtering is used, only content having similarity to the content selected by the user in the past is recommended. For this reason, as content that gives the user a sense of novelty is not recommended, the user loses interest in the recommendation result.

In addition to the content-based filtering, collaborative filtering is known as another structure that has been widely used in content recommendation. The collaborative filtering is similar to the content-based filtering in terms of using an action history of a user, however, the collaborative filtering has a structure in which the similarity of users rather than the similarity of content is taken into consideration. A system that uses the collaborative filtering, for example, searches for similar users that are similar to a target user based on the features of the user estimated from an action history and recommends content selected by the similar users in the past to the target user. For example, Japanese Unexamined Patent Application Publication No. 2002-334256 discloses the collaborative filtering.

When the above-mentioned collaborative filtering is used, since content selected by the similar users who perform a similar action is recommended, content that is not similar to those selected by the target user in the past may be recommended. As a result, there is a chance of content that gives the user a sense of novelty being recommended. However, in a system in which the collaborative filtering is used, there is a possibility that content popular to all users of the system may be easily recommended, and further, content like noise that is not suitable for the preference of the target user may be recommended.

### SUMMARY

As described above, the content-based filtering and the collaborative filtering are widely used in systems for recommending content. However, in systems using these filtering methods, it is difficult to recommend content that gives a user a sense of novelty while the intrinsic preference of the user is considered. In addition, while research has also been conducted on a hybrid-type structure in which the content-based filtering and the collaborative filtering are combined, there are many problems to be solved, such as the complexity of a system, the magnitude of a processing load, and the like.

Therefore, the present technology has been conceived under the above-described circumstances, and it is desirable for the present technology to provide a novel and improved information processing apparatus, information processing method, and program that can provide users with information that gives a user a sense of novelty while the intrinsic preference of the user is considered under a lighter processing load.

According to an embodiment of the present technology, there is provided an information processing apparatus, including a difference applying unit that obtains, according to difference feature information indicating a difference between first feature information characterizing an action of a target user and second feature information characterizing another action performed by the target user after the foregoing action is performed and third feature information characterizing an action newly performed by the target user, fourth feature information, and a target extracting unit that extracts information based on the fourth feature information.

Further, according to another embodiment of the present technology, there is provided an information processing method, including obtaining, according to difference feature information indicating a difference between first feature information characterizing an action of a target user and second feature information characterizing another action performed by the target user after the foregoing action is performed and third feature information characterizing an action newly performed by the target user, fourth feature information, and extracting information based on the fourth feature information.

Further, according to still another embodiment of the present technology, there is provided a program that causes a computer to realize functions including difference application for obtaining, according to difference feature information indicating a difference between first feature information characterizing an action of a target user and second feature information characterizing another action performed by the target user after the foregoing action is performed and third feature information characterizing an action newly performed by the target user, fourth feature information, and target extraction for extracting information based on the fourth feature information.

According to the present technology described above, it is possible to provide a user with information that gives the user a sense of novelty while the intrinsic preference of the user is considered under a lighter processing load.

### BRIEF DESCRIPTION OF THE DRAWINGS

FIG. 1 is an illustrative diagram for the overview of four-term analogy;

FIG. 2 is an illustrative diagram for the flow of a process relating to the four-term analogy;

FIG. 3 is an illustrative diagram for multi-dimensionalization of the four-term analogy;

FIG. 4 is an illustrative diagram for a configuration of content meta data;

FIG. 5 is an illustrative diagram for a learning process (offline process) in a recommendation method using the four-term analogy;

FIG. 6 is an illustrative diagram for a recommendation process (online process) in the recommendation method using the four-term analogy;

FIG. 7 is an illustrative diagram for the overview of a recommendation method according to an embodiment of the present technology;

FIG. 8 is an illustrative diagram for the overview of a recommendation method (of a feature vector base) according to a first embodiment of the present technology;

FIG. 9 is an illustrative diagram for the overview of a recommendation method (of a word vector base) according to a second embodiment of the present technology;

FIG. 10 is an illustrative diagram for a configuration of a recommendation system according to the first embodiment of the present technology;

FIG. 11 is an illustrative diagram for a configuration example of a feature database that is used in the recommendation system according to the first embodiment of the present technology;

FIG. 12 is an illustrative diagram for a configuration example of a variable database that is used in the recommendation system according to the first embodiment of the present technology;

FIG. 13 is an illustrative diagram for the flow (overview) of a learning process according to the first embodiment of the present technology;

FIG. 14 is an illustrative diagram for the flow (details) of the learning process according to the first embodiment of the present technology;

FIG. 15 is an illustrative diagram for the flow (overview) of a recommendation process (of a basic scheme) according to the first embodiment of the present technology;

FIG. 16 is an illustrative diagram for the flow (details) of the recommendation process (of the basic scheme) according to the first embodiment of the present technology;

FIG. 17 is an illustrative diagram for the flow (overview) of the recommendation process (of a user selection scheme) according to the first embodiment of the present technology;

FIG. 18 is an illustrative diagram for the flow (details) of the recommendation process (of the user selection scheme) according to the first embodiment of the present technology;

FIG. 19 is an illustrative diagram for a display method (Display Example #1) of a recommendation reason according to the first embodiment of the present technology;

FIG. 20 is an illustrative diagram for a display method (Display Example #2) of the recommendation reason according to the first embodiment of the present technology;

FIG. 21 is an illustrative diagram for a method of cross-category recommendation according to the first embodiment of the present technology;

FIG. 22 is an illustrative diagram for a configuration of a recommendation system according to the second embodiment of the present technology;

FIG. 23 is an illustrative diagram for the flow (overview) of a learning process according to the second embodiment of the present technology;

FIG. 24 is an illustrative diagram for the flow (details) of the learning process according to the second embodiment of the present technology;

FIG. 25 is an illustrative diagram for the flow (overview) of a recommendation process according to the second embodiment of the present technology;

FIG. 26 is an illustrative diagram for the flow (details) of the recommendation process according to the second embodiment of the present technology; and

FIG. 27 is an illustrative diagram for a hardware configuration example in which the function of each structural element of a recommendation system according to each embodiment of the present technology can be realized.

### DETAILED DESCRIPTION OF THE EMBODIMENT(S)

Hereinafter, preferred embodiments of the present disclosure will be described in detail with reference to the appended drawings. Note that in this specification and the appended drawings, structural elements that have substantially the same function and structure are denoted with the same reference numerals, and repeated explanation of these structural elements is omitted.

### [Course of Description]

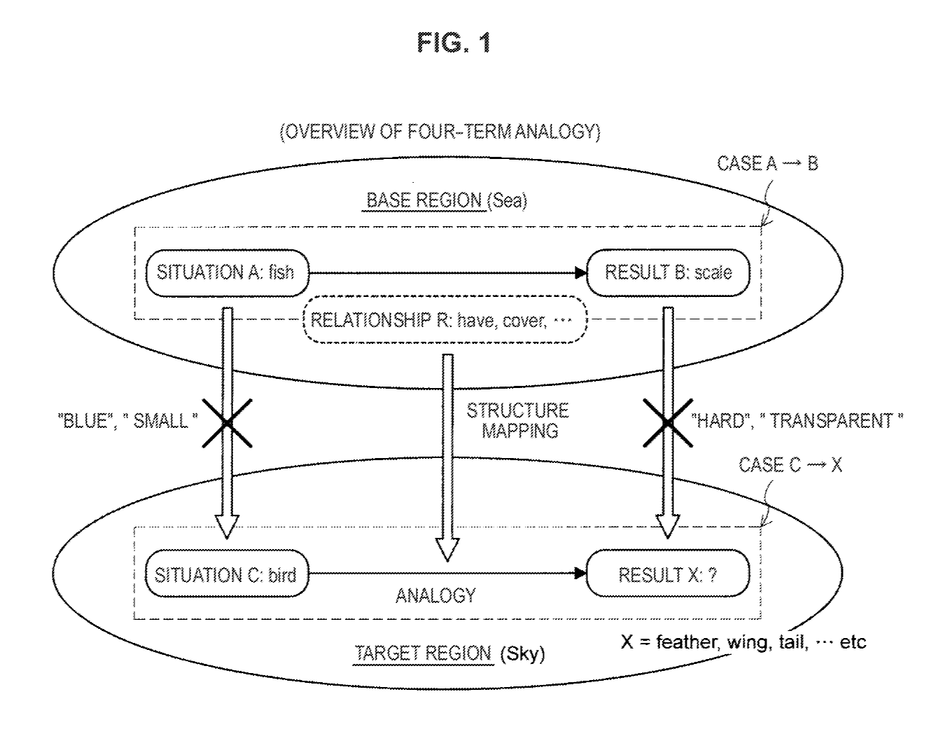

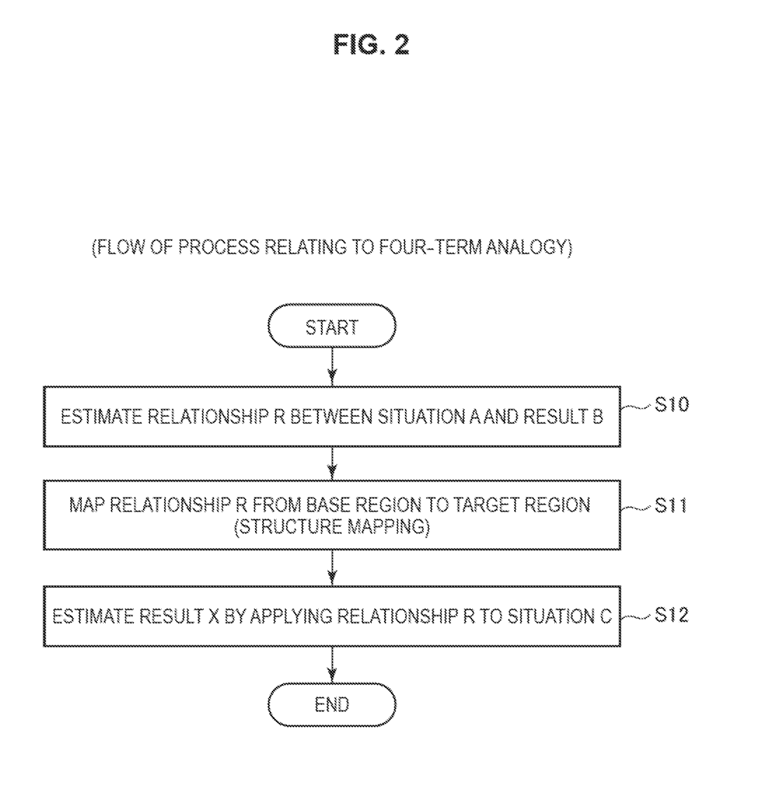

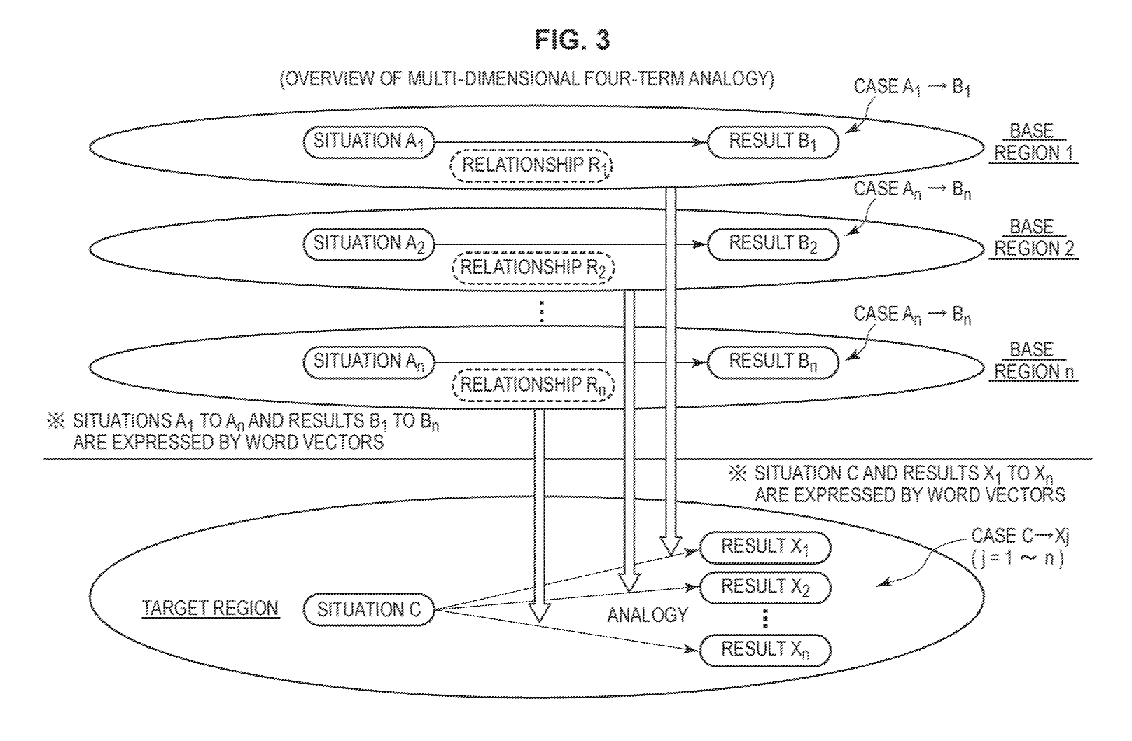

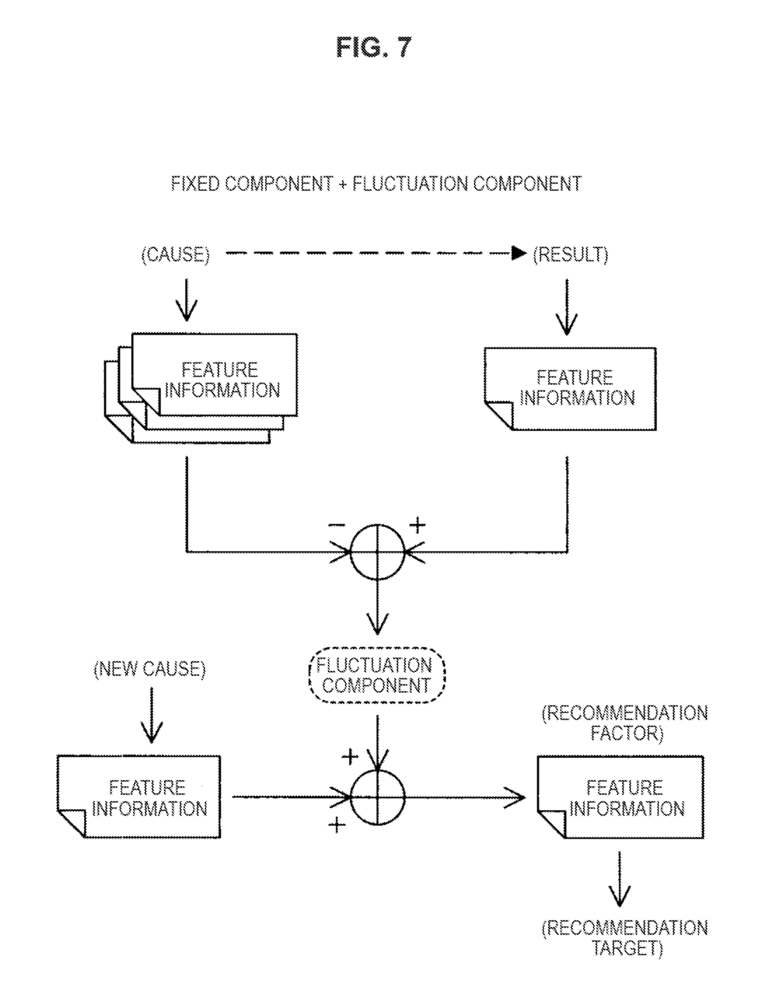

Herein, the course of description to be provided below will be briefly described. Therein, the concept of four-term analogy that serves as a reference for understanding the technologies of the embodiments to be described below will first be described with reference to FIGS. 1 and 2. Next, examples of a method for multi-dimensionalizing the four-term analogy and a recommendation method using the four-term analogy will be briefly described with reference to FIGS. 3 to 6. Then, the overview of the embodiments to be described later will be described with reference to FIGS. 7 to 9.

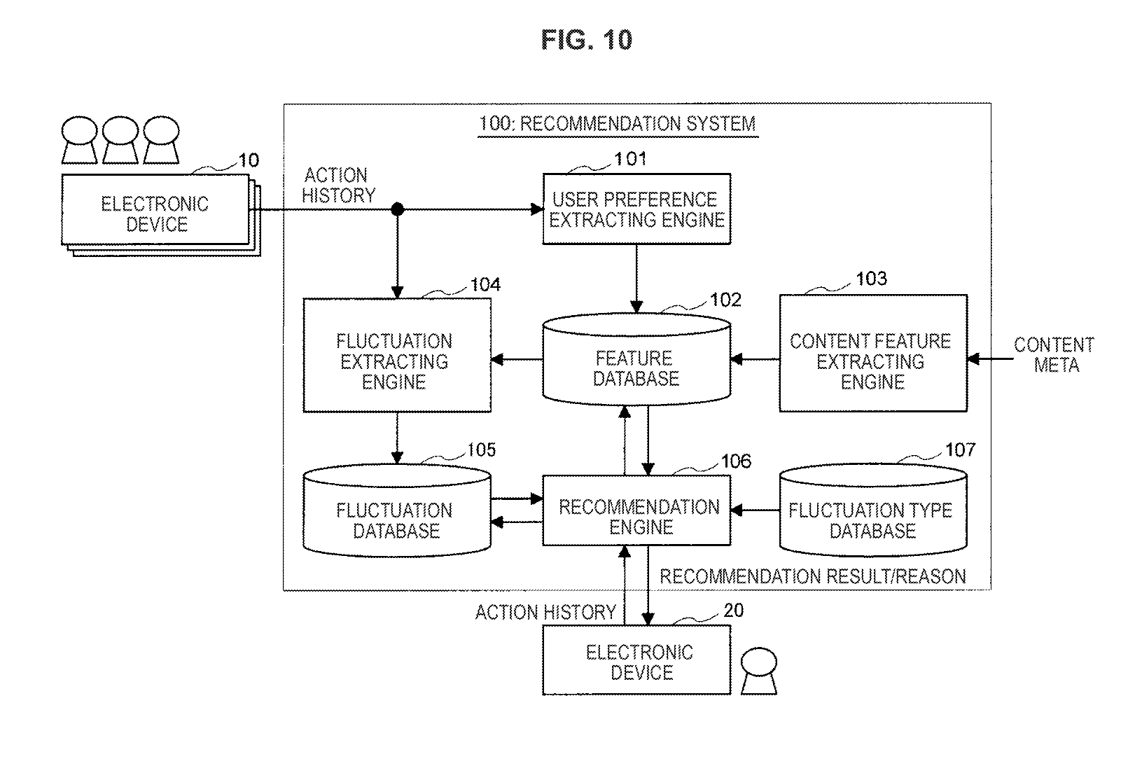

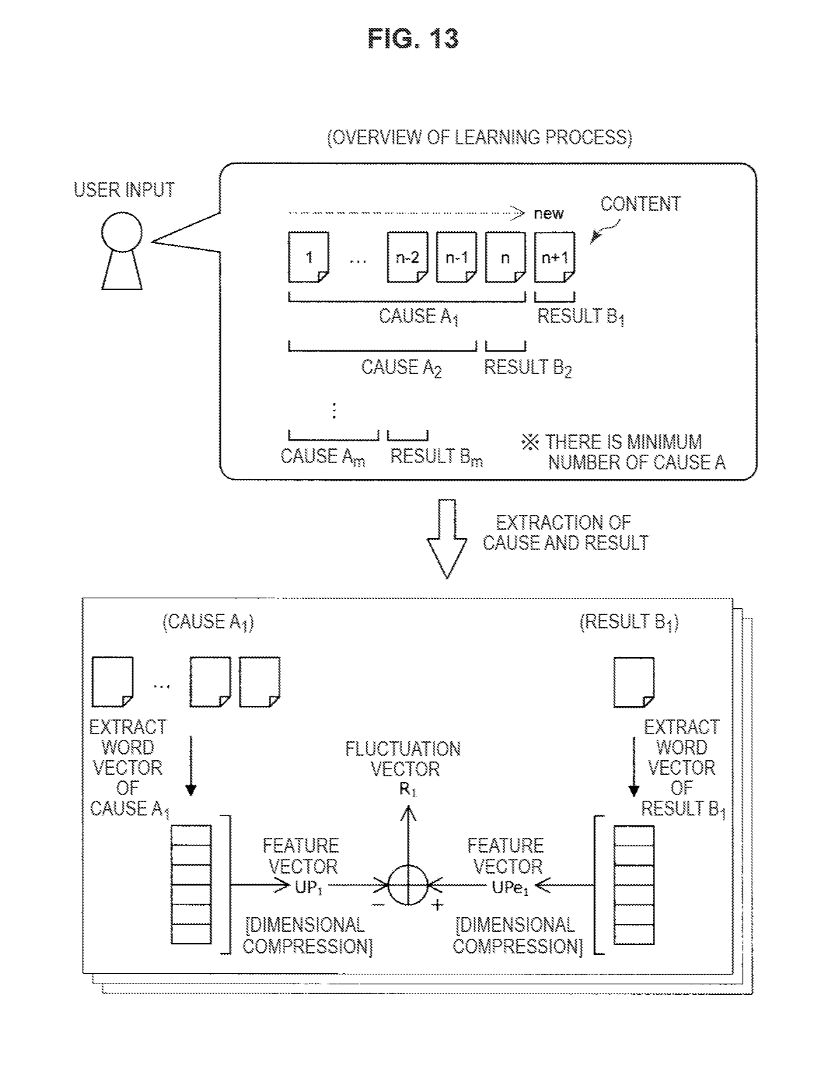

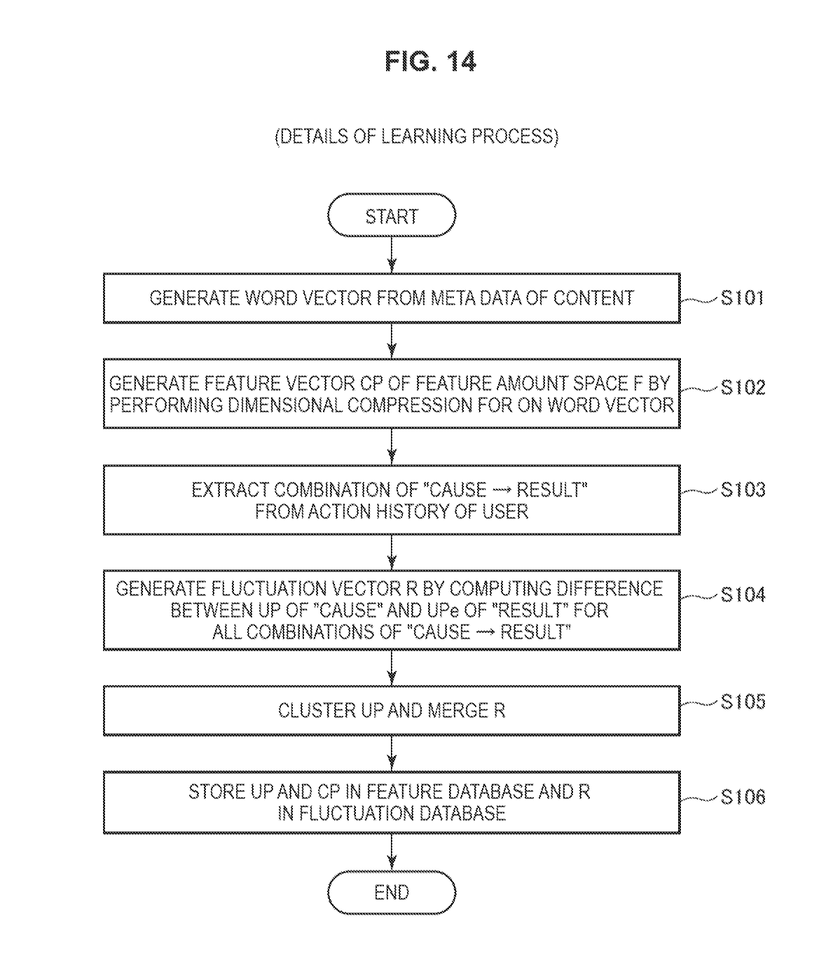

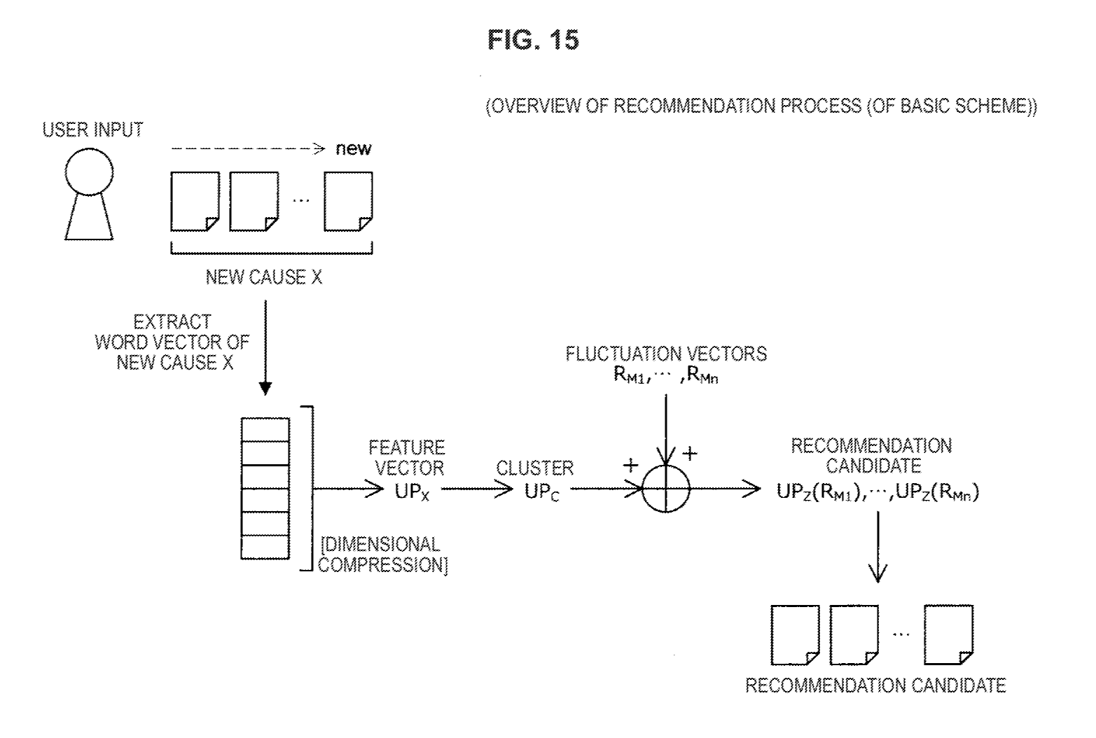

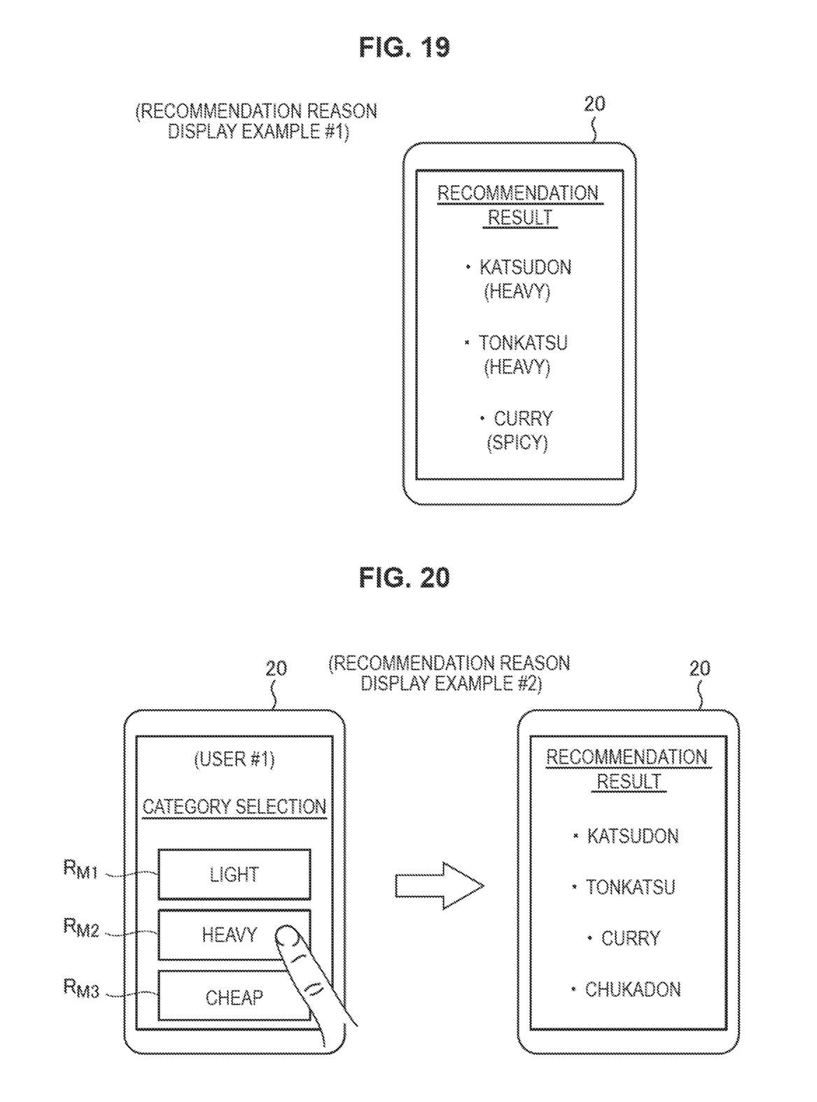

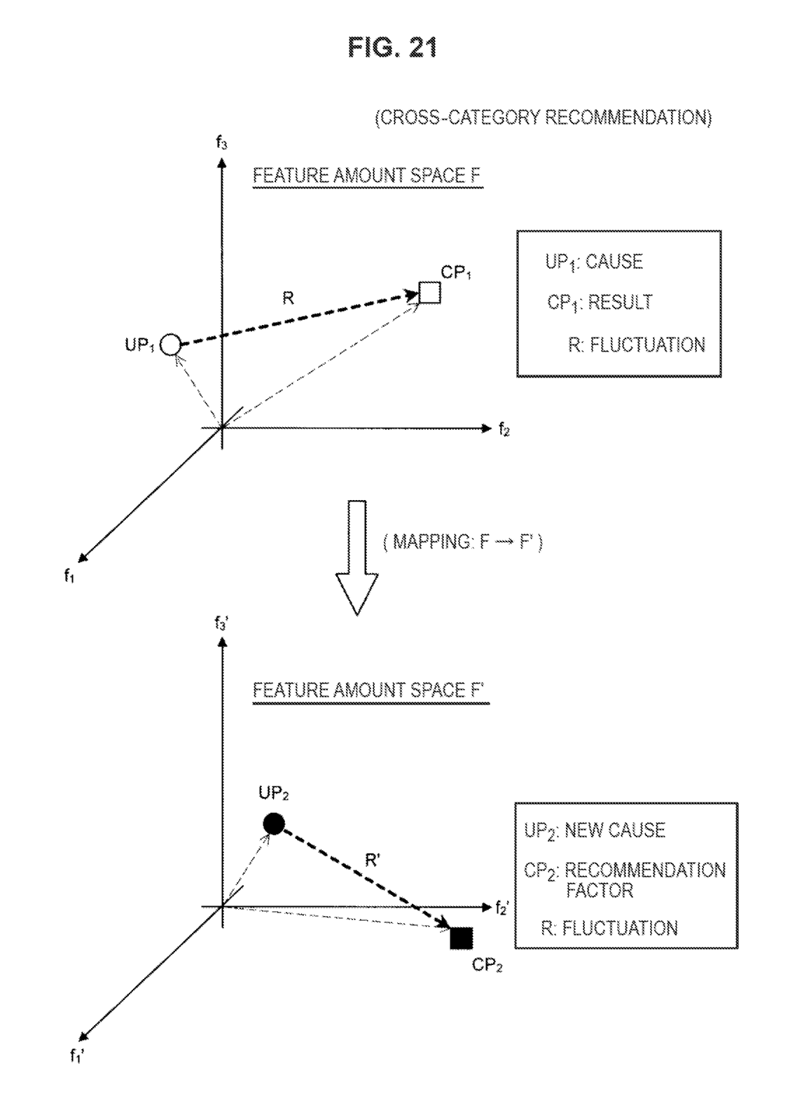

Next, a first embodiment of the present technology will be described with reference to FIGS. 10 to 21. Therein, a configuration of a recommendation system 100 according to the embodiment will first be described with reference to FIGS. 10 to 12. Then, the flow of a learning process executed in the recommendation system 100 will be described with reference to FIGS. 13 and 14. Then, the flow of a recommendation process executed in the recommendation system 100 will be described with reference to FIGS. 15 to 18. Then, a display method for a recommendation reason according to the embodiment will be described with reference to FIGS. 19 and 20. Then, a method for cross-category recommendation according to the embodiment will be described with reference to FIG. 21.

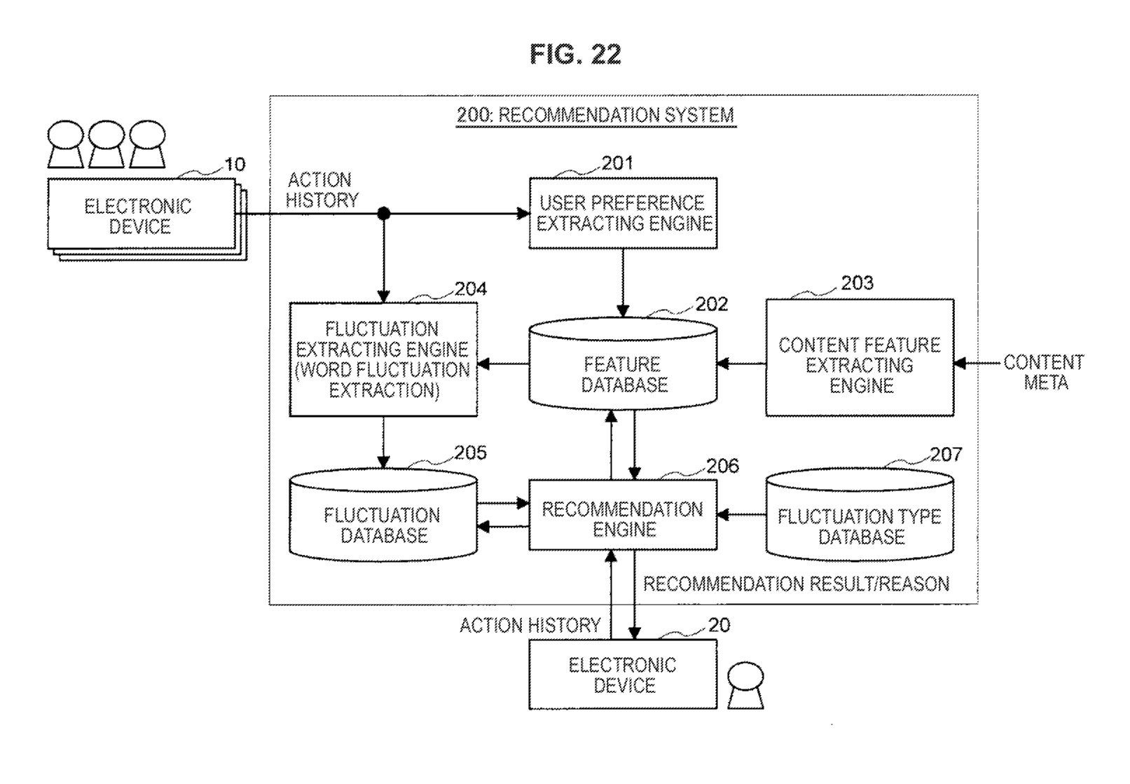

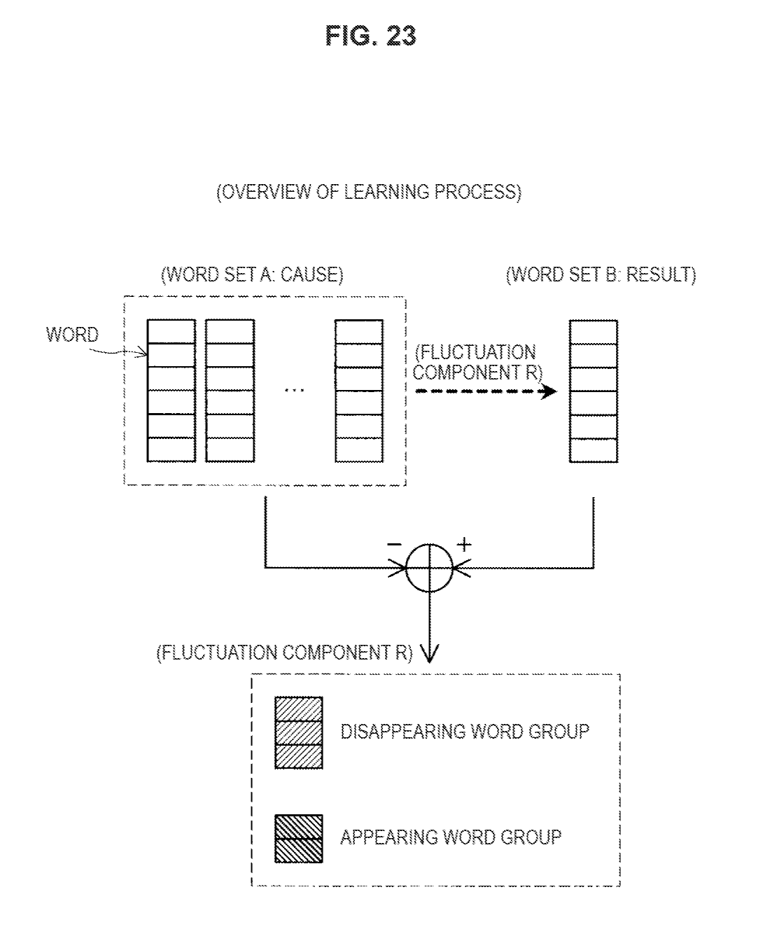

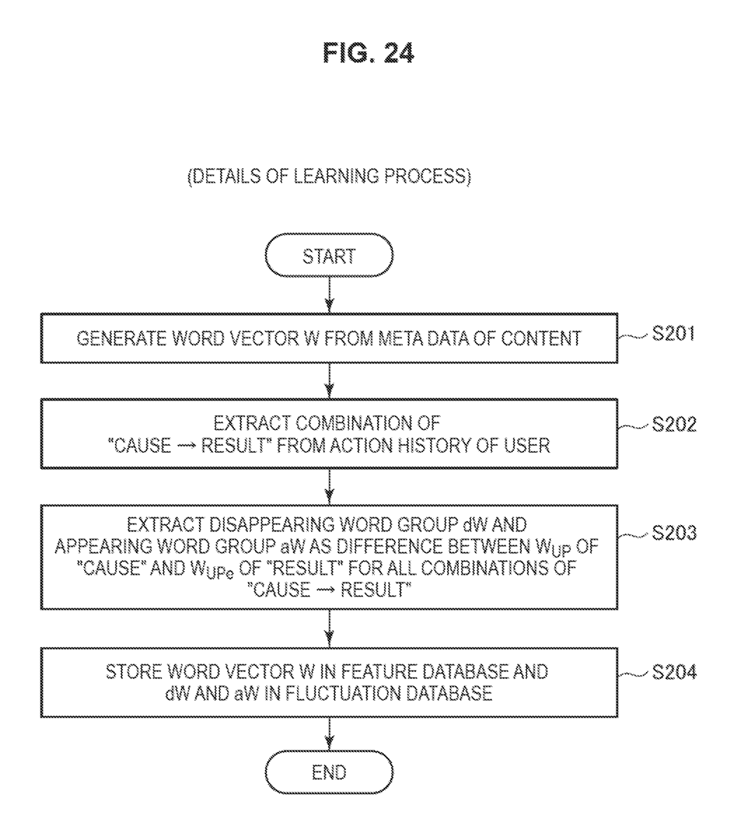

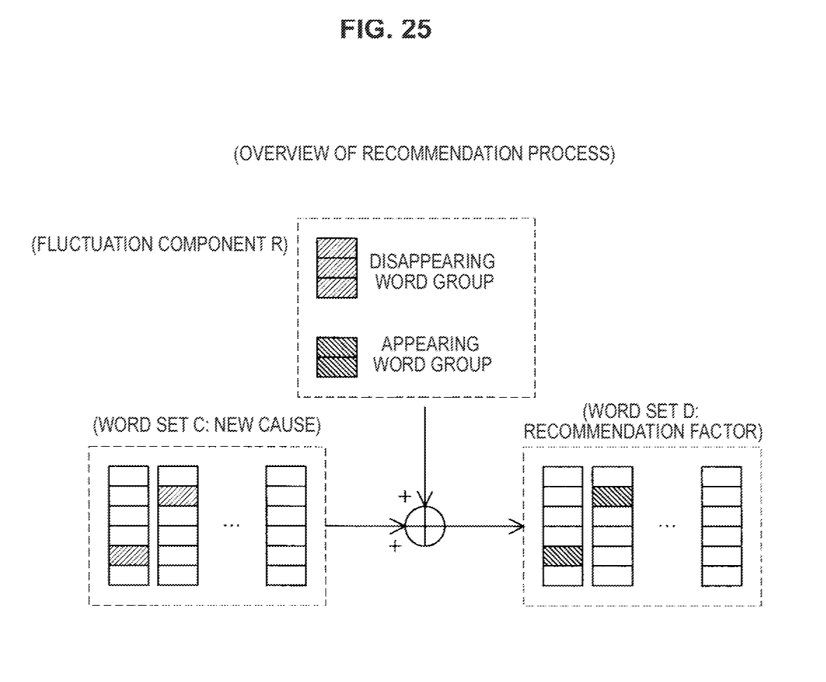

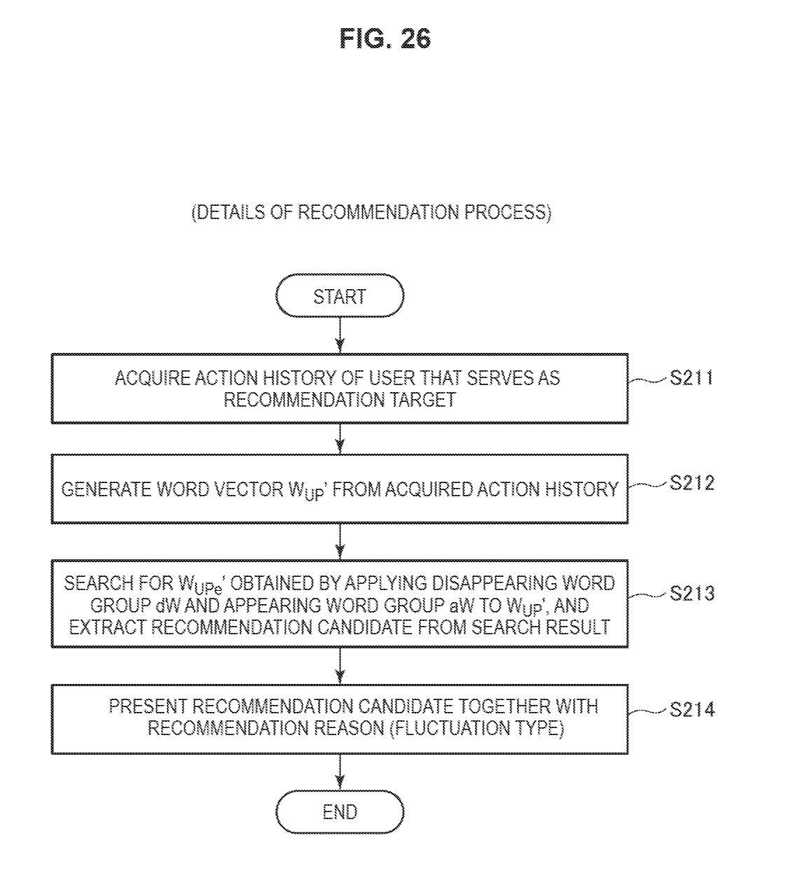

Next, a second embodiment of the present technology will be described with reference to FIGS. 22 to 26. Therein, a configuration of a recommendation system 200 according to the embodiment will first be described with reference to FIG. 22. Then, the flow of a learning process executed in the recommendation system 200 will be described with reference to FIGS. 23 and 24. Then, the flow of a recommendation process executed in the recommendation system 200 will be described with reference to FIGS. 25 and 26. Then, a method for combining the technique (of a word vector base) according to the embodiment and the technique (of a feature vector base) according to the first embodiment will be described.

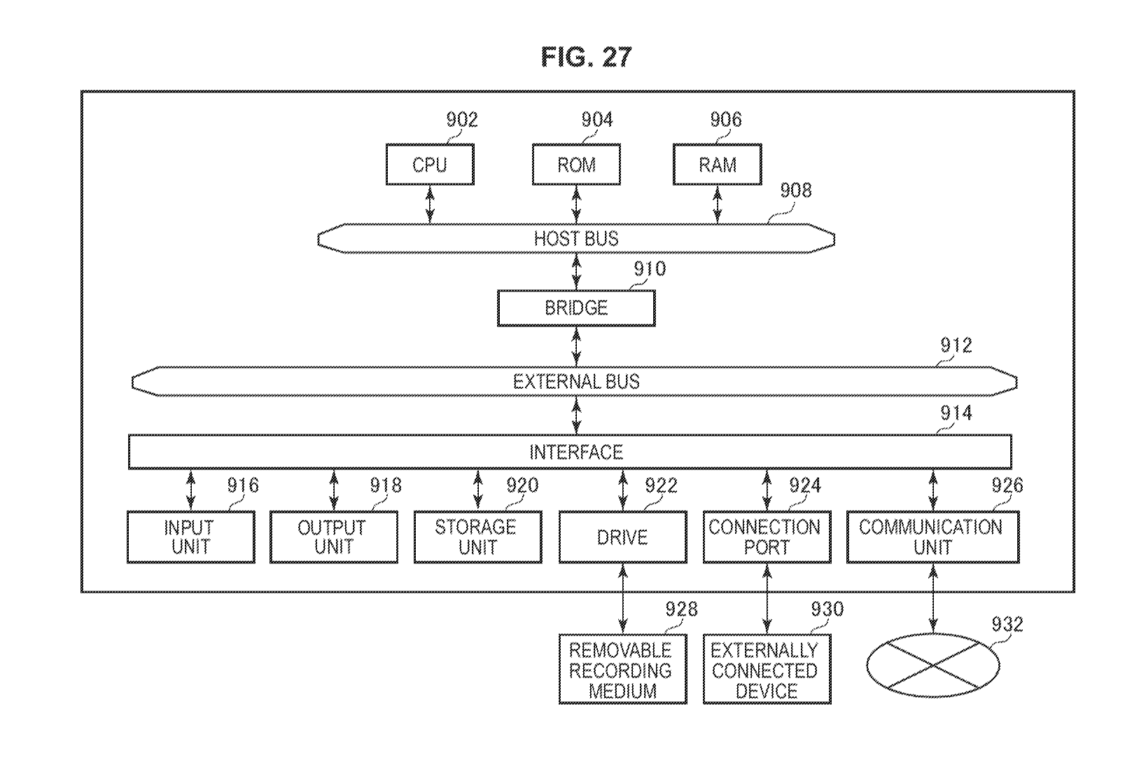

Next, with reference to FIG. 27, a hardware configuration example in which the function of each structural element of a recommendation system according to each embodiment of the present technology can be realized will be described. Lastly, the effect obtained from the technical idea of the embodiments will be briefly described with the summary of the idea.

### DESCRIPTION ITEMS

1: Introduction
   1-1: What is Four-Term Analogy?
   1-2: Multi-Dimensionalization of Four-Term Analogy
   1-3: Example of Recommendation Method Using Four-Term Analogy
      1-3-1: Offline Process
      1-3-2: Online Process
   1-4: Overview of Embodiment
      1-4-1: Idea
      1-4-2: Example of Feature Vector Base
      1-4-3: Example of Word Vector Base
2: First Embodiment (Feature Vector Base)
   2-1: System Configuration
   2-2: Flow of Learning Process
      2-2-1: Overview
      2-2-2: Details
   2-3: Flow of Recommendation Process (of Basic Scheme)
      2-3-1: Overview
      2-3-2: Details
   2-4: Flow of Recommendation Process (of User Selection Scheme)
      2-4-1: Overview
      2-4-2: Details
      2-5: Display of Recommendation Reason
      2-6: Cross-Category Recommendation
3: Second Embodiment (Word Vector Base)
   3-1: System Configuration
   3-2: Flow of Learning Process
      3-2-1: Overview
      3-2-2: Details
   3-3: Flow of Recommendation Process
      3-3-1: Overview
      3-3-2: Details
   3-4: Combination with Feature Vector Base
4: Regarding Applicability
5: Hardware Configuration Example
6: Summary

### 1: Introduction

First, the concept of the four-term analogy that serves as references for understanding techniques of embodiments to be described later, a recommendation method using the four-term analogy and the overview of the embodiments to be described below will be described.

### [1-1: What is Four-Term Analogy? (FIGS. 1 and 2)]

First of all, the concept of the four-term analogy will be described with reference to FIG. 1. FIG. 1 is an illustrative diagram for the concept of the four-term analogy.

The four-term analogy refers to modeling of a process in which a person analogizes a thing based on premise knowledge. When information C is given to a person having premise knowledge of “Case: AB,” what is information X that the person analogizes from the information C? For example, if the word “fish” is given as A and the word “scale” is given as B, the person may bring a concept expressed by the words “have,” “cover,” and the like to mind as a relationship R between A and B. Then, if the word “bird” is given to the person as information C to cause him or her analogize the information X based on the relationship R, the person is expected to analogize, for example, the words “feather,” “wing,” and the like. In this way, to model of an analogy process of a person is the four-term analogy.

In regard to the four-term analogy, attention has been paid to a technique for estimating a solution X of “Case: C→X” analogized by a person to whom “Case: A→B” is given as premise knowledge. Note that hereinbelow, there is a case in which a process of analogizing “Case: C→X” from “Case: A→B” is expressed by “A:B=C:X.” As a technique for estimating the solution X of “A:B=C:X,” for example, an estimation method that is called a structure mapping theory is known. This estimation method is to estimate the solution X (hereinafter, a result X) by applying the relationship R between A (hereinafter, a situation A) and B (hereinafter, a result B) of “Case: A→B” to C (hereinafter, a situation C) of “Case: C→X” as shown in FIG. 1.

In other words, the above-described structure mapping theory can also be said to be a method for mapping a structure of a knowledge region (hereinafter, a base region) constituting premise knowledge to a region of a problem to find the solution X (hereinafter, a target region). In regard to the structure mapping theory, for example, there is description in D. Gentner, “Structure-Mapping: A Theoretical Framework for Analogy,” Cognitive Science, 1983, or the like.

When the above-described structure mapping theory is used, it is possible to obtain an analogy result X that is reasonable to some degree, by excluding insignificant knowledge that comes up when the structure of a base region is mapped. For example, as shown in FIG. 1, when the word “fish” is given as the situation A, knowledge of “blue,” “small,” and the like analogized from the word “fish” can be excluded during the estimation of the result X. Similarly, when the word “scale” is given as the result B, knowledge of “hard,” “transparent,” and the like can be excluded during the estimation of the result X.

An estimation process of the result X based on the structure mapping theory is executed in, for example, the procedure shown in FIG. 2. First, as shown in FIG. 2, a process of estimating the relationship R between the situation A and the result B is performed (S10). Next, a process of mapping the relationship R estimated in Step S10 from the base region to the target region is performed (S11). Then, a process of estimating the result X by applying the relationship R to the situation C is performed (S12). By performing the processes of Steps S10 to S12, the solution X of “Case: C→X” is estimated based on “Case: AB”.

Hereinabove, the concept of the four-term analogy has been briefly described. Research on systemizing the concept of the four-term analogy described herein from the perspective of the fuzzy theory has been conducted by Kaneko et al., and the outcome of the research has been reported. For example, there are reports of “A Proposal of Analogical Reasoning Based on Structural Mapping and Image Schemas” by Yosuke Kaneko, Kazuhiro Okada, Shinichiro Ito, Takuya Nomura, and Tomihiro Takagi in the 5^{th} International Conference on Soft Computing and Intelligent Systems and the 11^{th} International Symposium on Advanced Intelligent Systems (SCIS & ISIS 10) in 2010, and the like. In the reports, Kaneko et al. have proposed a recommendation system in which a relationship R that serves as a mapping target is extracted from a co-occurrence frequency of a word and information of the part of speech of a word is used as a structure. The report may also help understanding of the concept of the four-term analogy.

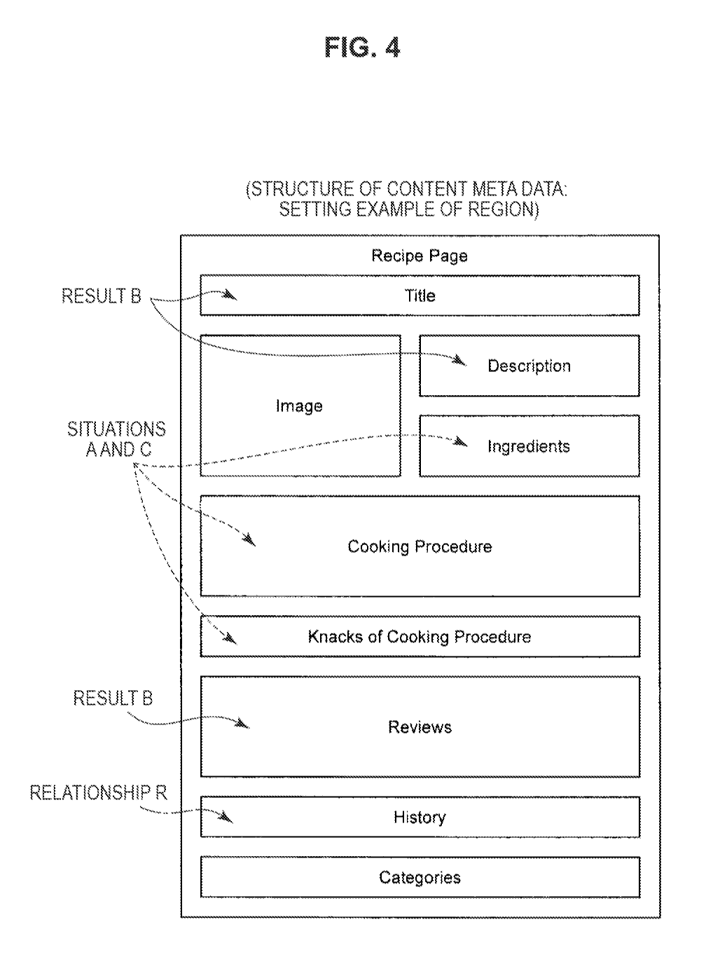

### [1-2: Multi-Dimensionalization of Four-Term Analogy (FIGS. 3 and 4)]

Next, a method for multi-dimensionalizing the four-term analogy will be described with reference to FIG. 3. FIG. 3 is an illustrative diagram for the method for multi-dimensionalizing the four-term analogy. Note that in regard to multi-dimensionalizing the four-term analogy, the method disclosed in, for example, Japanese Patent Application No. 2011-18787 has been proposed. The method will be briefly covered.

The example of FIG. 1 is structure mapping from one base region to one target region. In addition, in the example of FIG. 1, the situation A, the result B, the situation C, and the result X are each expressed by one word. Herein, a method is considered in which the concept of the four-term analogy is extended and a structure is mapped from a plurality of base regions to one target region, as shown in FIG. 3. In addition, herein, it is premised that each of the situation A, the result B, the situation C, and the result B is expressed by a word vector including one or a plurality of words. Note that the method considered herein is set to be called “multi-dimensional four-term analogy.” Hereinafter, the concept of the multi-dimensional four-term analogy will be briefly described.

As shown in FIG. 3, n base regions (a base region 1 to a base region n) are considered. In addition, in a base region k (k=1 to n), “Case: Aₖ→Bₖ” is included. Furthermore, a situation Aₖ and a result Bₖ are set to be expressed by word vectors including a plurality of words. In addition, structures of the base region 1 to the base region n are set to be mapped to one target region. Furthermore, in the target region, “Case: C→Xⱼ (j=1 to n)” is included. However, the relationship Rₖ between the situation Aₖ and the result Bₖ is used in estimating a result Xₖ of “Case: C→Xₖ.”

For example, the situation Aₖ (k=1 to n) is expressed by a word vector characterizing the preference of a person (hereinafter, a target user) which is extracted from a content group that was selected by the target user in the past. In addition, the result Bₖ (k=1 to n) is based on the premise of the situation Aₖ and expressed by a word vector characterizing content selected by the target user after the content group. Furthermore, the relationship Rₖ (k=1 to n) is expressed by a word vector characterizing the relationship between the situation Aₖ and the result Bₖ. Then, the situation C is expressed by a word vector characterizing the preference of the target user which is extracted from a content group including content newly selected by the target user. In addition, the result Xₖ (k=1 to n) is expressed by a word vector characterizing content analogized based on the word vectors of the situation C and the relationship R.

In other words, a result X₁ is analogized using a relationship R₁ between a situation A₁ and a result B₁, and the situation C. In a similar manner, a result X₂ is analogized from a relationship R₂ and the situation C, a result X₃ is analogized from a relationship R₃ and the situation C, . . . , and a result Xₙ is analogized from a relationship Rₙ and the situation C. Note that each word vector is generated, for example, using an algorithm called TF-IDF. TF-IDF is an algorithm for extracting a feature word from a document. TF-IDF outputs an index called a TF-IDF value. The TF-IDF value is expressed by a product of a TF value indicating an appearance frequency of a word and an IDF value indicating an inverse appearance frequency.

For example, if the number of times a word j appearing in a document d is set to the total number of words included in the document d is set to N, the total number of documents is set to D, and the number of documents in which the word j appears is set to Dⱼ, a TF value tf(j, d) is expressed by the following formula (1). In addition, an IDF value idf(j) is expressed by the following formula (2). In addition, a TF-IDF value tfidf(j, d) is expressed by the following formula (3). That is, a TF-IDF value of a word appearing in most documents decreases, and a TF-IDF value of a word frequently appearing in specific documents increases. For this reason, it is possible to extract words characterizing individual documents using the indexes. In addition, by extracting a plurality of words with high TF-IDF values, a word vector characterizing a document is generated.

tf(j,d)=Nⱼ/N (1)

idf(j)=1+ln(D/Dⱼ) (2)

tfidf(j,d)=tf(j,d)·idf(j) (3)

Herein, an example in which a recipe contribution site is used as an information source will be considered. Most recipe contribution sites are configured such that users can freely contribute recipes of their own created foods thereto. In addition, such a recipe contribution site is configured such that other users who have read the recipe contribution site can write reviews thereon. Of course, similar to other information sites, fields for title, image, and description are provided in the recipe contribution site. In addition, among the recipe contribution sites, there are sites provided with fields for ingredients, the cooking procedure, the knack of cooking, the history of food, the registration category, and the like. These fields are defined as meta data.

As shown in FIG. 4, for example, the structure of a recipe contribution site is constituted by meta data such as Title, Image, Description, Ingredients, Cooking Procedure, Knacks of Cooking Procedure, Reviews, History, Categories, and the like. Among these, the fields for Title, Description, Ingredients, Cooking Procedure, Knacks of Cooking Procedure, Reviews, and History include information that can be used in multi-dimensional four-term analogy.

As shown in FIG. 4, for example, the fields for Ingredients, Cooking Procedure, and Knacks of Cooking Procedure can be used as information sources of the situation A and the situation C. In addition, the fields for Title, Description, and Reviews can be used as information sources of the result B. Furthermore, the fields for History can be used as an information source of the relationship R.

That is to say, the information sources of the situation A and the situation B are set in a region indicating the preference of a user (in this example, ingredients, the cooking procedure, the knacks of cooking, and the like). Meanwhile, the information sources of the result B are set in a region in which the result of actual tasting of a food posted on the recipe contribution site, and the like are described. In addition, the information source of the relationship R is set in a region in which the relationship between the situation A and the result B (the process until the food posted on the recipe contribution site is created, or the like) is described. In this way, using the structure of the meta data, it is possible to easily set the information sources of the situation A, the result B, the situation C, and the relationship R. In addition, word vectors corresponding to the situation A, the result B, and the situation C can be generated from documents disclosed in each region using the above-described TF-IDF value, or the like.

Although an example in which a recipe contribution site is used as information sources has been considered herein, information sources of the situation A, the result B, the situation C, and the relationship R can also be set in other types of sites by referring to the structure of meta data. Note that an information source of the result X is set in a region to which the same meta data as that of an information source of the result B is given. If an information source is set in this manner, it is possible to estimate results X₁ to Xₙ based on multi-dimensional four-term analogy as shown in FIG. 3 using word vectors extracted from the history of sites that a user has read, or the like.

Hereinabove, the concept of the four-term analogy has been briefly described. The present inventors have conceived a structure in which the multi-dimensional four-term analogy as described herein is applied to recommendation of content. In regard to the structure, the specification of Japanese Patent Application No. 2011-72324 has been described in detail, however, the content thereof will be briefly introduced herein in order to clarify a difference between the structure and the embodiments to be described below.

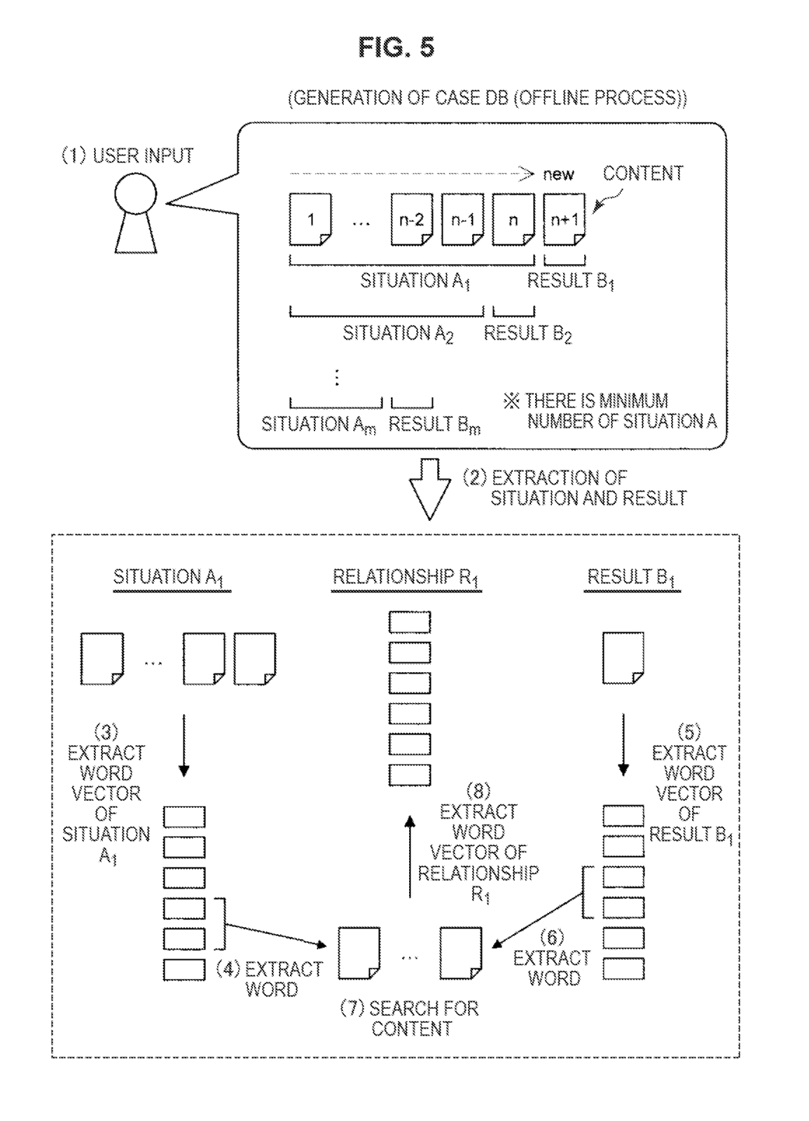

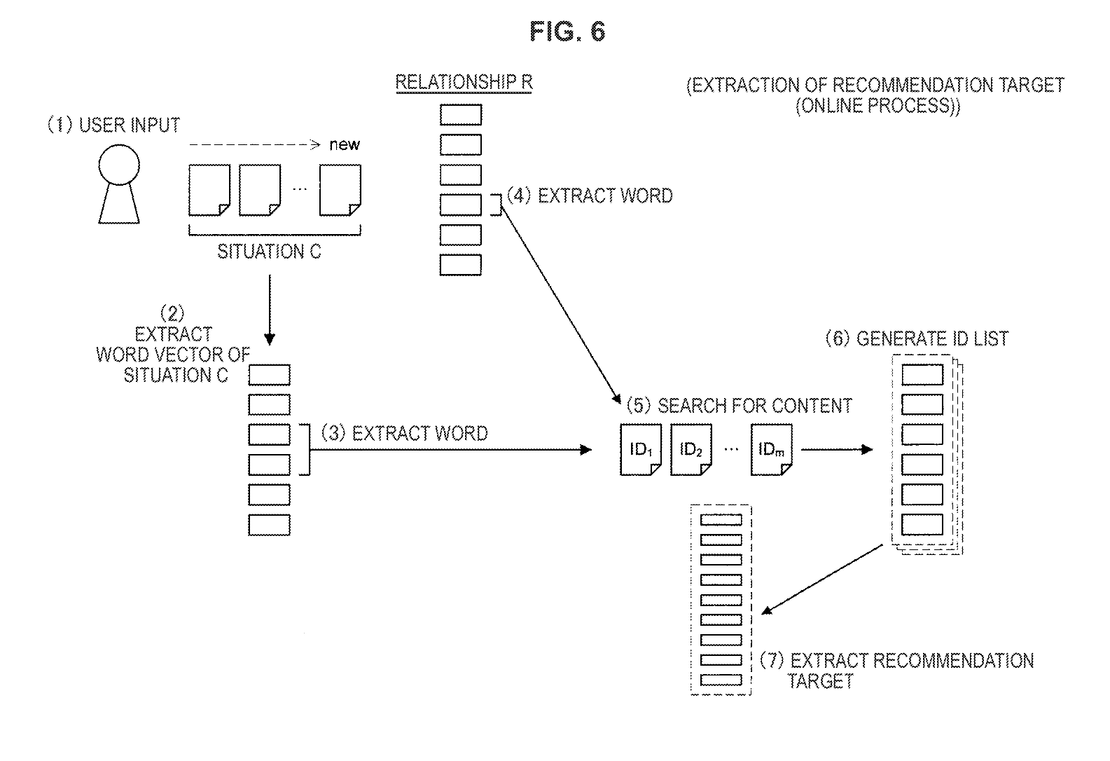

### [1-3: Example of Recommendation Method Using Four-Term Analogy (FIGS. 5 and 6)]

Recommendation methods of an information processing system using the multi-dimensional four-term analogy are broadly divided into an offline processing method in which a case group to be used in recommendation is generated from a learning process and an online processing method in which content is recommended using the case group generated in the offline process. Hereinbelow, the offline processing method and the online processing method will be described in that order.

### (1-3-1: Offline Process (FIG. 5))

First, the offline processing method will be described with reference to FIG. 5. As described above, the main process item to be achieved as the offline process is the generation of a case group.

In the offline process, a content group generated by a user in the past is used. To this end, as shown in FIG. 5, there is a process called the generation of content by a user ((1) user input) before the offline process. In the example of FIG. 5, n+1 pieces of content including content 1 to content n+1 have been prepared. Note that content given with a higher number is defined to be one that is lastly generated. First, the information processing system selects n pieces of content in the order in which they were generated from the n+1 pieces of content as information sources of the situation A. In addition, the information processing system selects the latest content as an information source of the result B. Herein, n pieces of content selected as the information sources of the situation A are expressed by a situation A₁, and the content selected as the information source of the result B is expressed by a result B₁.

Similarly, in regard to q=1, . . . , m−1, the information processing system selects n-q pieces of content as information sources of the situation A in the order in which they were generated. In addition, the information processing system selects new content as an information source of the result B in the order of q+1. In regard to each of q=1, . . . , m−1, n−q pieces of content selected as the information sources of the situation A are expressed by a situation A_{(q+1)}, and the content selected as the information source of the result B is expressed by a result B_{(q+1)}. Here, m is set so that the number of pieces of content corresponding to a situation Aₘ reaches a predetermined number. If a pair of a situation Aₖ (K=1, . . . , m) and a result Bₖ is extracted in this manner (2), the information processing system generates a word vector characterizing a relationship Rₖ between the situation Aₖ and the result Bₖ for each of k=1, . . . , m.

As an example, a generation method of a word vector characterizing a relationship R₁ between a situation A₁ and a result B₁ will be described herein. First, the information processing system refers to a region that is set as an information source of the situation A (hereinafter, a region A) so as to generate a word vector characterizing the region (3), for n pieces of content corresponding to the situation A₁. For example, the information processing system generates n word vectors that respectively characterize the region A of the content 1 to n, and integrates the n word vectors to be set as a word vector of the situation A₁. Next, the information processing system extracts words (two words in the example) from the word vector of the situation A₁ (4). Note that in the description below, there may be a case in which a pair of words extracted herein is called a word vector of the situation A₁.

Next, the information processing system generates a word vector characterizing a region set as an information source of the result B (hereinafter, a region B) for the content corresponding to the result B₁, and sets the word vector to be a word vector of the result B₁ (5). Then, the information processing system extracts words (two words in this example) from the word vector of the result B₁ (6). Note that there may be a case in which a pair of words extracted herein is also called a word vector of the result B₁ in the description below. Then, the information processing system searches for content in which the words extracted from the word vector of the situation A₁ are included in the region A and the words extracted from the word vector of the result B₁ are included in the region B (7).

Next, the information processing system generates a word vector characterizing a region set as an information source of the relationship R (hereinafter, a region R) for the content extracted from the search process, and sets the word vector to be a word vector of the relationship R₁ (8). However, when a plurality of pieces of content are extracted from the search process, a plurality of word vectors that respectively characterize the region R of each content are generated, and the plurality of word vectors are integrated so as to be set as a word vector of the relationship R. The word vector of the relationship R₁ generated in this manner is retained in the information processing system in association with the words extracted from the word vector of the situation A₁ and the words extracted from the word vector of the result B₁.

Note that there are many combinations of words extracted from the word vectors. For this reason, the above-described processes of (4), (6), (7), and (8) are executed for all combinations of different words. Then, sequentially, the word vector generated in the above-described (8) is added to the word vector of the relationship R₁. In addition, the processes described above are executed not only for the combination of the situation A₁ and the result B₁ but also all combinations of situations A₂, . . . , Aₘ and results B₂, . . . , Bₘ. Then, word vectors of relationship R₁, . . . , Rₘ are generated. As a result, the preparation of a case group to be used in an online process to be described below is completed.

Hereinabove, the offline processing method in the recommendation method using the multi-dimensional four-term analogy has been described.

### (1-3-2: Online Process (FIG. 6))

Next, an online processing method will be described with reference to FIG. 6. As described above, the main process executed in an online process is searching for content using a case group and posting of the search result. Note that the online process mentioned herein means a process executed when a recommendation request is received from a user.

As described above, the online process is performed when a recommendation request has been received. In other words, the online process is performed when a user has selected new content. As illustrated in FIG. 6, when new content is selected ((1) user input), the information processing system extracts a word vector of the situation C (2). At this moment, the information processing system first extracts a word vector indicating the preference of the user (hereinafter, a preference vector), and then updates the preference vector using words characterizing a region (hereinafter, a region C) that is set as an information source for the situation C of the new content. Then, the information processing system sets the preference vector that has undergone updating to be a word vector of the situation C.

Next, the information processing system extracts words (two words in this example) from the word vector of the situation C (3). Then, the information processing system extracts a word (one word in this example) from the word vector of the relationship R referring to the case group generated in the offline process (4). Then, the information processing system searches for content in which the words extracted from the word vector of the situation C appear in the region C and the word extracted from the word vector of the relationship R appears in the region R (5). Then, the information processing system generates a list of item IDs (hereinafter, a recommendation list) showing the content extracted in the search process (6).

There are a plurality of combinations of the words extracted from the word list of the situation C and the word extracted from the word list of the relationship R. For this reason, a recommendation word list generation process is repeatedly performed for different combinations so as to generate a plurality of recommendation lists. The information processing system integrates the plurality of recommendation lists and gives a score to each of pieces of recommendation content. Then, the information processing system selects a combination of pieces of recommendation content to be recommended based on the given score, and generates a recommendation list that includes selected pieces of recommendation content (7). Then, the information processing system presents the recommendation list to the user who has sent the recommendation request.

Hereinabove, the online processing method in the recommendation method using the multi-dimensional four-term analogy has been described.

As described above, the recommendation method using the multi-dimensional four-term analogy relates to a structure in which the relationship connecting a situation and a result is extracted from an action history of a user and recommendation content is searched for using the relationship and a new situation. Note that, in the description above, as an action history of the user, a selection history of content by the user has been exemplified, however, the same approach as the above is also considered to be possible for other action history. In other words, it is said that the recommendation method has a structure in which the relationship between an action of the past and a result caused by the action is extracted and content is recommended which is to be recommended with information indicating a new action and information indicating the extracted relationship as key information.

However, attention should be paid to the above-described recommendation method in that the relationship between both sides of the information indicating a situation and indicating a result is not extracted by directly using the information, but information included in a field showing the relationship of results obtained by searching for both sides of the information as key information is used as the relationship. The technique according to the embodiments to be described later relates to a structure in which information characterizing an action that serves as a cause and information characterizing an action that serves as a result are directly used, a preference change of a user arising from the course from the cause to the result is accurately captured, and the preference change is exploited in recommendation.

### [1-4: Overview of Embodiment (FIGS. 7 to 9)]

Hereinafter, the overview of an embodiment will be briefly described.

### (1-4-1: Idea (FIG. 7))

First, the overview of the common technical idea of first and second embodiments to be described later will be briefly described with reference to FIG. 7.

In the technique according to the present embodiment, a component is extracted with which the preference of the user changes between an action of the user that serves as a cause and an action made by the user as a result of the foregoing action, and a recommendation target is extracted in consideration of a fixed preference and changing preference of the user. FIG. 7 schematically illustrates the concept thereof. As illustrated in FIG. 7, the system according to the present embodiment prepares feature information characterizing the action that serves as the cause (hereinafter, cause feature information) and feature information characterizing the actions that serves as the result (hereinafter, result feature information), and extracts the difference between the result feature information and the cause feature information. Furthermore, the system regards the extracted difference as a component of a preference change (hereinafter, a fluctuation component), and generates feature information (hereinafter, a recommendation factor) that causes the fluctuation component to affect a new structure of the user so as to be used in extraction of a recommendation target. Then, the system searches for a recommendation target based on the generated recommendation factor.

When the relationship between the cause (situation) and the result is to be extracted in the recommendation method using the multi-dimensional four-term analogy, the feature of the cause and the feature of the result are used as key information so as to search for content in which both features are shown together, and information indicating the relationship is extracted from the search result. For this reason, it is difficult to say that, in the information indicating the relationship, various elements other than the preference change of the user arising from the course from the cause to the result are included, and the fluctuation component mentioned in the present embodiment is extracted. In other words, it can be said that, while the changing preference and the fixed preference of the user are separated from each other in the technique according to the embodiment, the concepts of change and fixation in preference is not particularly considered in the recommendation method using the multi-dimensional four-term analogy. From this point, the technique of the present embodiment and the recommendation method using the multi-dimensional four-term analogy are significantly different from each other.

Hereinafter, the overview of an example in which the technical idea according to the present embodiment is implemented will be described.

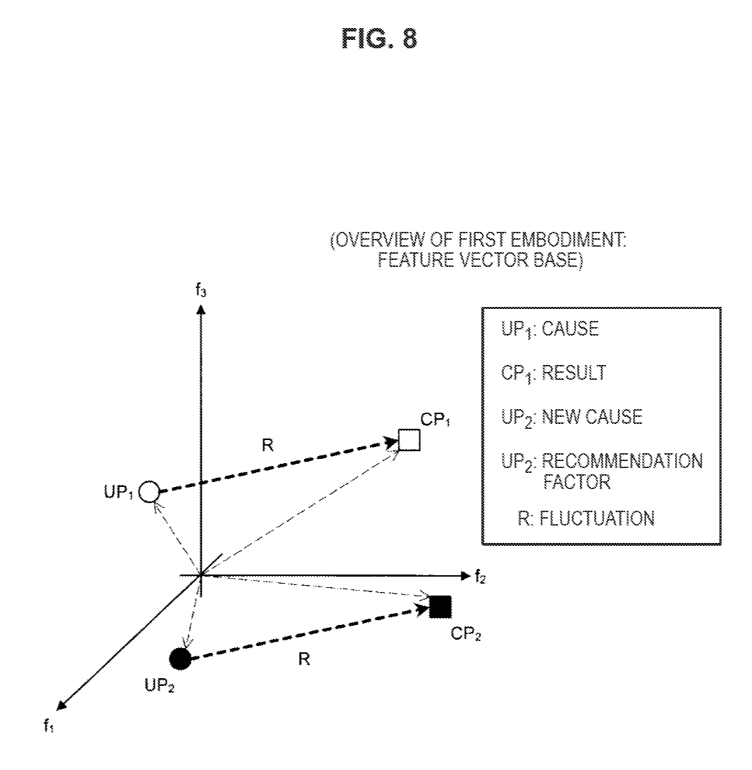

### (1-4-2: Example of Feature Vector Base (FIG. 8))

First, FIG. 8 is referred to. A structure will be introduced herein in which a recommendation factor is computed by expressing an action of a user by feature vectors and expressing a fluctuation component by a difference of the feature vectors. A specific realization method of the structure will be described in detail in a first embodiment to be described below.

As illustrated in FIG. 8, an action of a user can be expressed using feature vectors in a given feature amount space F. Note that, as an action of a user, various examples of, for example, selecting, purchasing, reading, writing, pressing, supplying, eating, moving, riding, walking, exercising, reserving, brushing one's teeth, laundering, cooking, working, discussing, calling, documenting, driving, and the like can be raised. Those actions have specific objects that serve as targets of the actions (hereinafter, targets). For example, for the actions of “selecting” and “purchasing,” a borrowed item, goods for sale, and the like are the targets. In addition, for “supplying,” water, and the like are the target. Furthermore, for “eating,” udon, sushi, grilled meat, and the like are the targets. The targets can be identified using information expressing them (hereinafter, content) such as words or word groups, photos and sounds, and the like. However, when such targets are text, music, videos, and the like, the targets themselves serve as content.

The content as described above can be characterized using certain feature amounts. For example, content expressed by text is characterized by word vectors constituted by word groups characterizing the content. In addition, music data is characterized by, for example, a tempo or melody information such as the progress of codes obtained by analyzing a signal waveform. In addition to that, there are methods under research for characterizing content using various mechanical learning techniques. The example of FIG. 8 shows a method of expressing each content by feature vectors in a feature amount space. Note that each feather vector characterizes an action of a user or content corresponding to the action. In addition, FIG. 8 shows only three axes (f₁, f₂, and f₃) that define the feature amount space for the convenience of description, but the number of dimensions in a feature amount space is not limited to three.

If the feature vectors are used as illustrated in FIG. 8, an action of a user corresponding to a cause is expressed by, for example a feature vector UP₁. In a similar manner, an action of the user corresponding to the result is expressed by a feature vector CP₁. Thus, a fluctuation component indicating a preference change of the user arising from the course from the cause to the result can be expressed by a feature vector R (hereinafter, a change vector R). The feature vector R is the difference of the feature vector UP₁ and the feature vector CP₁. In addition, when the user performs a new action, the new action (action of the user corresponding to a new cause) is expressed by a feature vector UP₂. Thus, when it is desired to obtain a recommendation target according to a new cause, the system computes, as a recommendation factor, a feature vector CP₂ by combining the feature vector UP₂ and the change vector R, and extracts a recommendation target corresponding to the feature vector CP₂.

Note that the feature vector CP₂ may be obtained by combining the feature vector UP₂ and the change vector R without change, but actually, a method is adopted in which the feature vector CP₂ approximate to a feature vector obtained by combining the feature vector UP₂ and the change vector R is searched for using both elements. For example, the system extracts a number of combinations of causes and results from an action history of a user, and prepares combinations of feature vectors corresponding to the causes, the results, and fluctuation components by projecting the causes and results in a feature amount space. Furthermore, the system makes clusters of the feature vectors, and prepares feature vectors of causes representing each of the clusters and a change vector R that extends from the feature vectors of each of the clusters. In addition to that, the system selects a cluster in the vicinity of the feature vector UP₂, and searches for the feature vector CP₂ using feature vectors representing the cluster and the change vector R.

As described above, as a method of realizing the technical idea according to the present embodiment, an example using feature vectors can be considered. Hereinbelow, a scheme relating to the example is referred to as a feature vector base. Note that the scheme will be described in detail in the first embodiment to be described below.

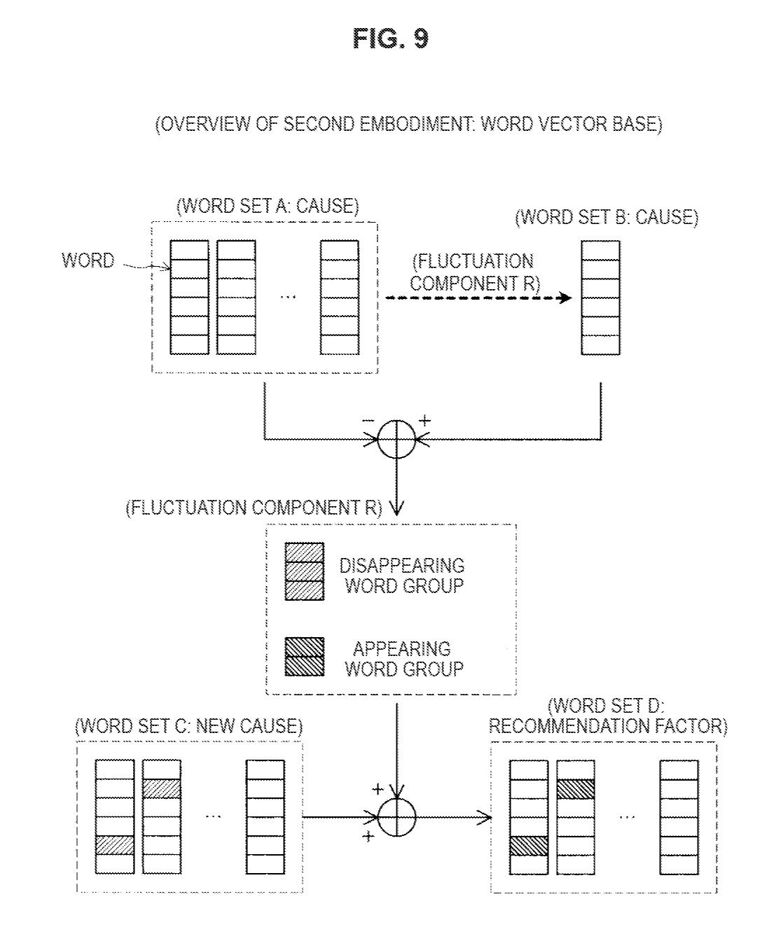

### (1-4-3: Example of Word Vector Base (FIG. 9))

Next, FIG. 9 will be referred to. A structure will be described herein in which an action of a user is expressed by word vectors and a recommendation factor is computed by expressing a fluctuation component by a difference of the word vectors. A specific method for realizing the structure will be described in detail in a second embodiment to be described below.

As illustrated in FIG. 9, each content characterizing an action of a user can be expressed by word vectors constituted by one or a plurality of words. Furthermore, an action of a user is characterized by a word set constituted by one or a plurality of word vectors. For example, an action of a user corresponding to a cause is characterized by a word set A. In addition, an action of the user corresponding to the result is characterized by a word set B. In this case, a preference change of the user arising from the course from the cause to the result is expressed by a fluctuation component R indicating the difference between the word set A and the word set B.

As illustrated in FIG. 9, an element of the fluctuation component R is divided into a disappearing word group and an appearing word group. The disappearing word group is a group of words disappearing in the course from the cause to the result. That is to say, the disappearing word group is a group of words that exist in the word set A, but do not exist in the word set B. On the other hand, the appearing word group is a group of words newly appearing in the course from the cause to the result. That is to say, the appearing word group is a group of words that do not exist in the word set A, but exist in the word set B. In this way, in the case of the feature vector base, a fluctuation component is expressed by a feature vector, but in the case of the word vector base, a fluctuation component is expressed by disappearance and appearance of words. However, it should be understood that even if different expression methods are used in this manner, the technical idea relating to the present embodiment described above is realized in the same manner.

If a word set C corresponding to a new cause is given, for example, the system can generate a word set D that serves as a recommendation factor by making the fluctuation component R affect the word set C. The “affect” mentioned above means an operation in which the disappearing word group is deleted from the word set C and the appearing word group is added to the word set C. By performing such an operation, a preference change of the user arising from the course from the cause to the result is reflected on the new cause, and then a recommendation factor can be obtained which precisely reflects the preference change of the user in addition to a fixed preference of the user. The system searches for a recommendation target using the word set D generated in this manner. Note that, even in such a scheme using the word sets, a practical technique using the clustering can be constructed in the same manner as in the feature vector base. In addition, it is possible to use a combination of the technique and the feature vector base technique.

As described above, as a method for realizing the technical idea according to the present embodiment, an example using word sets is considered. Hereinbelow, the scheme based on the example is referred to as a word vector base. Note that the scheme will be described in detail in the second embodiment to be described below.

### 2: First Embodiment

### Feature Vector Base

The first embodiment of the present technology will be described. The present embodiment relates to a recommendation algorithm of a feature vector base.

### [2-1: System Configuration (FIGS. 10 to 12)]

First, a system configuration example of a recommendation system 100 according to the first embodiment will be described with reference to FIGS. 10 to 12. FIGS. 10 to 12 are illustrative diagrams of the system configuration example of the recommendation system 100 according to the present embodiment. Note that the recommendation system 100 may be configured with one information processing apparatus having a hardware configuration shown in FIG. 27 or partial functions thereof, or may be configured with a plurality of information processing apparatuses connected via a local or a wide-area network or partial functions thereof. Of course, it is possible to arbitrarily set the type, communication scheme, and the like of a communication circuit constituting the network (for example, LAN, WLAN, WAN, the Internet, a mobile telephone line, a fixed telephone line, ADSL, an optical fiber, GSM, LTE, or the like).

First, FIG. 10 will be referred to. As illustrated in FIG. 10, the recommendation system 100 is mainly constituted by a user preference extracting engine 101, a feature database 102, a content feature extracting engine 103, a change extracting engine 104, a change database 105, a recommendation engine 106, and a change type database 107. Note that, although not illustrated in the drawing, the recommendation system 100 has a unit for acquiring information from external electronic devices 10 and 20. In addition, the electronic devices 10 and 20 may be different devices from each other, or may be the same device.

When a user acts, information of the action is input to the user preference extracting engine 101 and the change extracting engine 104 as an action history. Note that, hereinbelow, description will be provided by exemplifying an action of a user selecting content, for the convenience of description. In this case, information (for example, meta data) of content selected by the user by operating the electronic device 10 is input to the user preference extracting engine 101 and the change extracting engine 104 as an action history.

When the action history is input, the user preference extracting engine 101 extracts feature information CP characterizing content referring to meta data of the content included in the input action history. As the feature information CP, for example, word vectors constituted by word groups characterizing the content or feature vectors obtained by dimensionally compressing the word vectors are used. Hereinbelow, for the convenience of description, a method using feature vectors obtained by dimensionally compressing the word vectors as the feature information CP will be described.

When feature vectors are generated for each content included in the action history, the user preference extracting engine 101 stores the generated feature vectors in the feature database 102. Note that, in the description below, the feature vectors generated for each content will be denoted by CP. In addition, the user preference extracting engine 101 collects the feature vectors CP generated for the content included in the action history of each user, and then generates feature vectors UP indicating the preference of each user by superimposing the feature vectors CP. Then, the user preference extracting engine 101 stores the generated feature vectors UP in the feature database 102.

Note that, as a method for generating the feature vectors UP, for example, a method is considered in which the feature vectors UP with high scores are extracted from the feature vectors CP of content included an action history of a user, and then the results are set to the feature vectors UP. In addition, as another method, a method is considered in which word vectors are extracted from each content included in an action history of a user, words with high scores are generated from the vectors to generate new word vectors, and then feature vectors UP are generated by performing dimensional compression on the new word vectors. In use of the methods or other known methods, the feature vectors UP characterizing an action history of a user are generated by being directly or indirectly superimposed on the feature vectors CP generated for each user.

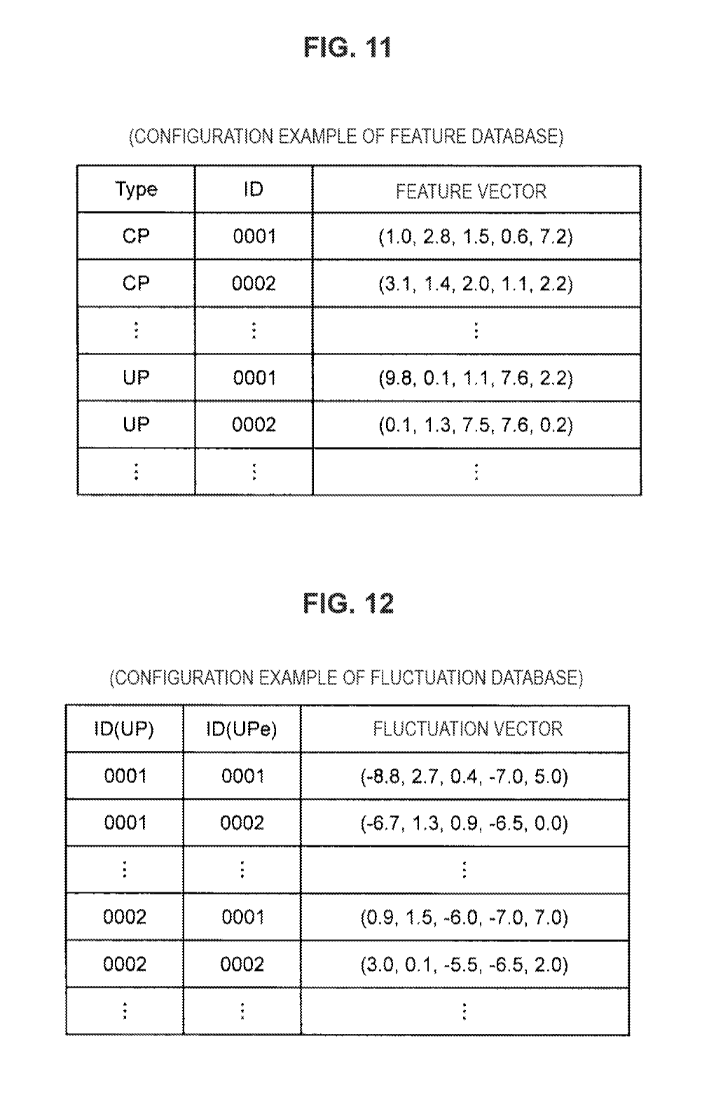

The feature vectors CP characterizing each content and the feature vectors UP characterizing the action history of the user are stored in the feature database 102 with a configuration as illustrated in, for example, FIG. 11. In the example of FIG. 11, the field indicating the type of the feature vectors (CP or UP), and the identification ID for identifying each type of the feature vectors and the details of the type of the feature vectors are stored in association with each other. Note that the configuration of the feature database 102 illustrated in FIG. 11 is an example, and for example, if a numbering rule for the identification ID is set so as to identify the types, the field for the types is not necessary. In addition, since the feature vectors are assumed to have undergone dimensional compression, the feature vectors of which each element is indicated by an actual value have been exemplified, but the format for displaying the feature vectors can be appropriately changed according to the idea of a format for expressing feature amounts.

Then, the feature database 102 can also store feature vectors CP of content not relating to the action history of the user. Such feature vectors CP are generated by the content feature extracting engine 103. The content feature extracting engine 103 acquires meta data of content from external information sources, and generates the feature vectors CP from the acquired meta data. The content feature extracting engine 103 generates, for example, the feature vectors CP in the form that the vectors match in the same feature amount space (hereinafter, a feature amount space F) as that of the feature vectors CP or UP generated by the user preference extracting engine 101.

In this manner, the feature database 102 stores the feature vectors CP and UP corresponding to a point in the feature amount space F that are obtained for the content included in the action history of the user and external content. Note that the feature database 102 is appropriately updated according to updates of the action history input to the user preference extracting engine 101 or changes of the external content acquired by the content feature extracting engine 103.

When the feature database 102 is constructed or updated in the manner described above, the change extracting engine 104 extracts a fluctuation component R indicating a preference change of the user arising from the course from a cause to the result using the feature vectors CP and UP stored in the feature database 102. In the case of the feature vector base, the fluctuation component R is expressed by the difference (hereinafter, a change vector R) between the feature vectors UP obtained from an action history corresponding to the cause and the feature vectors CP (hereinafter, UPe) obtained from an action history corresponding to the result.

First, the change extracting engine 104 divides an action history into combinations (hereinafter, cases) of causes and results as illustrated in FIG. 13. Then, the change extracting engine 104 extracts feature vectors UP and UPe of each case from the feature database 102, computes the difference of the vectors, and then generates the change vectors R. When the change vectors R are generated in this manner, the change extracting engine 104 stores the generated change vectors R in the change database 105. The change database 105 is configured as illustrated in, for example, FIG. 12. As illustrated in FIG. 12, an identification ID for identifying the feature vectors UP corresponding to the causes, an identification ID for identifying the feature vectors UPe corresponding to the results, and details of the change vectors R of both vectors are stored in association with each other. Note that, similar to the case of the feature database 102, the display format and configuration of the database can be appropriately changed.

When the feature database 102 and the change database 105 are constructed in this manner, it is possible to recommend content using information stored in the databases. Recommendation of content is realized as a function of the recommendation engine 106.

First, when a recommendation request is received from the user, the recommendation engine 106 starts a content recommendation process in accordance with the recommendation request. The recommendation request is issued based on a new action of the user. For example, when the user newly selects content by operating the electronic device 20, a recommendation request is sent to the recommendation engine 106 from the electronic device 20. At this moment, the electronic device 20 sends an action history of the user (information indicating the selecting action of new content, or the like) to the recommendation engine 106. When the action history is received, the recommendation engine 106 generates feature vectors UP′ characterizing the user from the feature vectors CP characterizing content included in the action history.

At this moment, when the feature vectors CP used in the generation of the feature vectors UP′ have been stored in the feature database 102, the recommendation engine 106 acquires the corresponding feature vectors CP from the feature database 102. On the other hand, when the feature vectors CP have not been stored in the feature database 102, the recommendation engine 106 generates the feature vectors CP characterizing the content included in the action history received from the electronic device 20 from meta data of the content. Then, the recommendation engine 106 generates the feature vectors UP′ by superimposing the feature vectors CP thereover. Note that the method of generating the feature vectors UP′ is substantially the same as that of the feature vectors UP by the user preference extracting engine 101. In other words, the feature vectors UP′ also match in the feature amount space F in which the feature vectors UP are regulated.

When the feature vectors UP′ are generated, the recommendation engine 106 searches for the feature vectors CP that serve as recommendation factors using the feature vectors UP′ and the change vectors R. Herein, a method of searching for the feature vectors CP will be discussed in more detail.

The change vectors R are stored in the change database 105. The change vectors R indicate changes in the preference of a user arising from the course from a cause to the result. For example, let us assume that a user A tends to drink “hot coffee” after having “katsudon.” On the other hand, let us assume that a user B tends to drink “hot green tea” after having “katsudon.” This preference change of each user is expressed by the change vectors R. However, there may be a case in which the user A drinks “hot coffee” sometimes, and drinks “hot green tea” the other times. Further, a resultant action may change according to things that the user has before “katsudon” or an action of the user performed until the user finishes “katsudon.”

A difference of resultant actions as described above is expressed as a difference of cases. As described before, the user preference extracting engine 101 generates a plurality of cases by changing combinations of the causes and the results of an action history of the same user, and obtains the feature vectors UP and UPe for the cases. Furthermore, the change extracting engine 104 generates the change vectors R for the feature vectors UP and UPe. Thus, various change vectors R in consideration of differences of cases are stored in the change database 105. For this reason, the recommendation engine 106 selects a change vector R having a feature vector UP in the vicinity of the feature vector UP′ as a starting point. Furthermore, the recommendation engine 106 selects a feature vector CP in the vicinity of a feature vector UPe′ obtained by combining the selected change vector R with the feature vector UP′ so as to set as a recommendation factor.

However, when a number of similar cases are present, after respectively clustering the feature vectors UP and UPe, it is favorable to select the feature vectors UP and UPe representing each cluster, or to merge the change vectors R into a vector connecting the clusters. In addition, a plurality of change vectors R may be made to match clusters corresponding to the feature vectors UP. Furthermore, each change vector R may be set with a score or a weight value. When the clustering is used, the recommendation engine 106 selects a cluster close to the feature vector UP′ and acquires a change vector R corresponding to the cluster. Then, the recommendation engine 106 searches for a recommendation factor by combining the feature vector UP′ with the change vector R.

In addition, when the change vector R is selected, the recommendation engine 106 reads information of the change type corresponding to the selected change vector R from the change type database 107, and supplies the information of the change type and a recommendation result to the user. When the change vector R indicates “heavy,” for example, the change type database 107 stores data (for example, text data, audio data, image data, or the like) indicating “heavy” as the information of the change type so as to match the change vector R. For this reason, the recommendation engine 106 provides the user with the data indicating “heavy” as a recommendation reason, together with the recommendation result detected using the recommendation factor based on the change vector R and the feature vector UP′ (for example, refer to FIG. 19). Note that the information of the change type may be used as information for identifying selection options when the user is made to select the change vector R (for example, refer to FIG. 20).

Hereinabove, the system configuration of the recommendation system 100 according to the present embodiment has been described. The system configuration described herein is an example, and it is possible to appropriately change some structural elements according to embodiments. It is needless to say that such a change is also within the technical scope of the present embodiment.

### [2-2: Flow of Learning Process (FIGS. 13 and 14)]

Next, the flow of a learning process according to the present embodiment will be described with reference to FIGS. 13 and 14. Note that the learning process mentioned herein means a construction process of the feature database 102, and the change database 105.

### (2-2-1: Overview (FIG. 13))

First, FIG. 13 will be referred to. FIG. 13 is an illustrative diagram for the overview of the learning process according to the present embodiment. In addition, note that the procedure illustrated in FIG. 13 is expressed by simplifying the processing order and details in order for the details of the learning process according to the present embodiment to be easily understood.

As illustrated in FIG. 13, the learning process according to the present embodiment includes the procedure for generating cases and the procedure for generating a change vector R for each case.

In the procedure for generating cases, a process is performed in which combinations of causes and results are selected and extracted from one action history as illustrated in the upper section of FIG. 13. For example, when there are n+1 pieces of content that serve as targets of the action history, as illustrated in FIG. 13, a case #1 is generated by setting the latest content to be a result B₁ and the previous content to be a cause A₁. In the same manner, in a content group from which the latest content is excluded, a result B₂ and a cause A₂ are selected, whereby a case #2 is generated. The same process is repeated, whereby a case #1, . . . , a case #m are obtained. Note that a minimum number may be set for the number of pieces of content that serve as causes.

When the case #1, . . . , the case #m are obtained, a procedure for generating a change vector R for each case is executed. When the case #1 is considered, for example, from a content group constituting the cause A₁, a word vector W₁ characterizing the content group is extracted, as illustrated in the lower section of FIG. 13. Furthermore, a feature vector UP′ is obtained from dimensional compression of the word vector W₁. Note that, herein, although the method has been exemplified in which the feature vector UP′ is obtained directly from the word vector W₁, a method of obtaining the feature vector UP from the feature vector CP of each content constituting the cause A₁ is not necessarily used but any one of the methods may be used.

Similarly, from content constituting the result B₁, a word vector W₁′ characterizing the content is extracted. Furthermore, a feature vector UPe₁ is obtained from dimensional compression of the word vector W₁′. Then, a change vector R₁ is generated by subtracting the feature vector UP′ from the feature vector UPe₁. Herein, the method for generating the change vector R₁ for the case #1 has been shown, but in the same manner, change vectors R₂, . . . , Rₘ respectively corresponding to cases #2, . . . , and #m are generated. The feature vectors generated in the above-described procedure are stored in the feature database 102, and the change vectors are stored in the change database 105.

Hereinabove, the overview of the learning process according to the present embodiment has been described. Note that clustering of the cases may be performed at the time at which the change vectors R for the cases #1, . . . , and #m are obtained. In this case, the feature vectors that have undergone clustering and the change vectors that have undergone merging are stored in the feature database 102 and the change database 105, respectively.

### (2-2-2: Details (FIG. 14))

Next, FIG. 14 will be referred to. FIG. 14 is an illustrative diagram for the flow of the learning process according to the present embodiment.

As illustrated in FIG. 14, the recommendation system 100 first generates word vectors characterizing content from meta data of the content (S101). Next, the recommendation system 100 performs dimensional compression on the word vectors generated in Step S101, and then generates the feature vectors CP of the feature amount space F (S102). Then, the recommendation system 100 extracts combinations (cases) of “causes→results” from an action history of a user (S103).

Next, the recommendation system 100 computes the differences between feature vectors UP of the “causes” and feature vectors UPe of the “results” for all combinations of “the causes and the results” extracted in Step S103, and then generates change vectors R (S104). Then, the recommendation system 100 clusters the feature vectors UP and merges the change vectors R (S105). Then the recommendation system 100 stores the feature vectors UP that have undergone the clustering and the feature vectors CP in the feature database 102, and stores the change vectors R that have undergone merging in the change database 105 (S106). After that, the recommendation system 100 ends a series of processes relating to the learning process.

Hereinabove, the flow of the learning process according to the present embodiment has been described. In the example of FIG. 14, description has been provided on the premise of clustering of the feature vectors and merging of the change vectors, but when the clustering process and the merging process are not performed, the learning process can be realized by omitting the steps relating to the above processes.

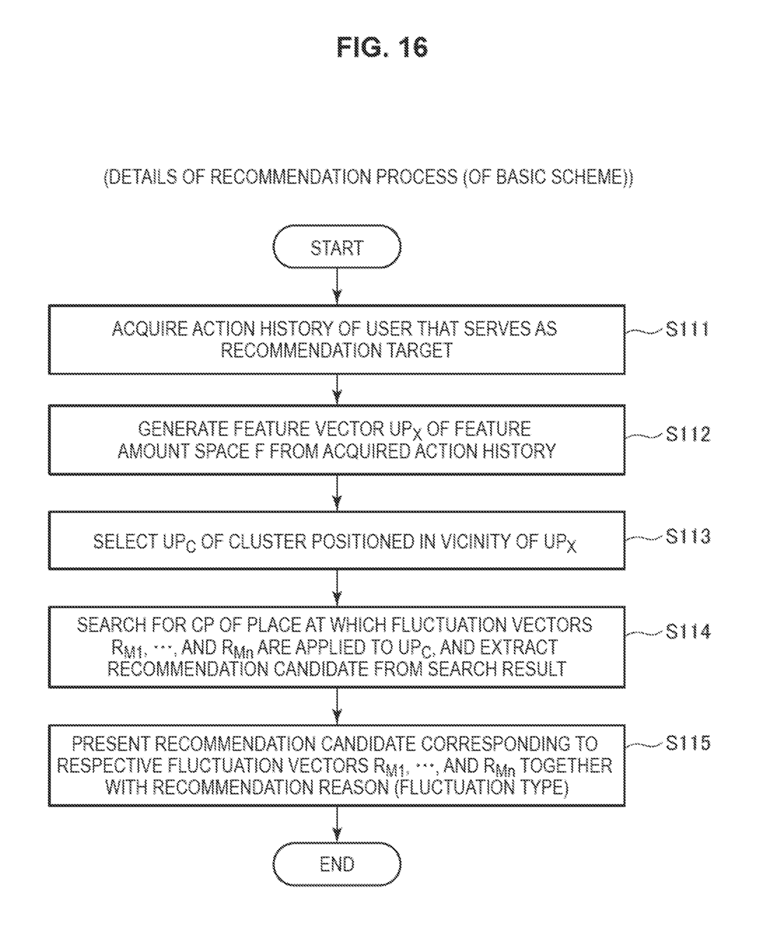

### [2-3: Flow of Recommendation Process (of Basic Scheme) (FIGS. 15 and 16)]

Next, the flow of a recommendation process according to the present embodiment will be described with reference to FIGS. 15 and 16. Note that the description will be provided herein on the premise that the clustering process for the feature vectors and the merging process for the change vectors are performed.

### (2-3-1: Overview (FIG. 15))

First, FIG. 15 will be referred to. FIG. 15 is an illustrative diagram for the overview of the recommendation process according to the present embodiment. Note that the recommendation process to be described below is realized mainly by the function of the recommendation engine 106.

As illustrated in FIG. 15, in the recommendation process, a new action history (a new cause X) of the user is used. First, the recommendation engine 106 extracts word vectors W characterizing a content group constituting the new cause X. Next, the recommendation engine 106 performs dimensional compression on the extracted word vectors W and then generates a feature vector UPₓ of the feature amount space F. Then, the recommendation engine 106 selects a cluster in the vicinity of the feature vector UPₓ, and then obtains a feature vector UP_{c} representing the cluster.

Next, the recommendation engine 106 acquires change vectors R_{M1}, . . . , and R_{Mn} that have undergone merging from the change database 105, and then combines each of the vectors with the feature vector UP_{c}. Then, the recommendation engine 106 uses feature vectors UP_{z} (R_{M1}), . . . , and UP_{z} (R_{Mn}) generated from the combining process as recommendation factors to search for recommendation candidates. Then, the recommendation engine 106 presents the user with a predetermined number of recommendation results out of the recommendation candidates. At this moment, the recommendation engine 106 presents the user with information of the change types (recommendation reason) together with the recommendation results.

Hereinabove, the overview of the recommendation process according to the present embodiment has been described.

### (2-3-2: Details (FIG. 16))

Next, the flow of the recommendation process according to the present embodiment will be described with reference to FIG. 16.

As illustrated in FIG. 16, the recommendation engine 106 first acquires an action history of the user that serves as a recommendation target (S111). Then, the recommendation engine 106 generates the feature vector UPₓ of the feature amount space F from the action history acquired in Step S111 (S112). At this moment, the recommendation engine 106 performs dimensional compression on the word vectors characterizing the action history of the user that serves a new cause, and then generates the feature vector UPₓ. Then, the recommendation engine 106 selects the feature vector UP_{c} of a cluster positioned in the vicinity of the feature vector UPₓ (S113).

Then, the recommendation engine 106 searches for feature vectors CP in the vicinity of the place at which the change vectors R_{M1}, . . . , and R_{Mn} are applied to the feature vector UP_{c}, and then extracts the recommendation candidates from the search result (S114). Then, the recommendation engine 106 presents the user with the recommendation candidates corresponding to each of the change vectors R_{M1}, . . . , and R_{Mn}, together with the recommendation reason (S115). At this moment, as the recommendation reason, information of the change type corresponding to the change vectors R_{M1}, . . . , and R_{Mn} is presented (for example, refer to FIG. 19). After that, the recommendation engine 106 ends a series of processes relating to the recommendation process.

Hereinabove, the flow of the recommendation process according to the present embodiment has been described.

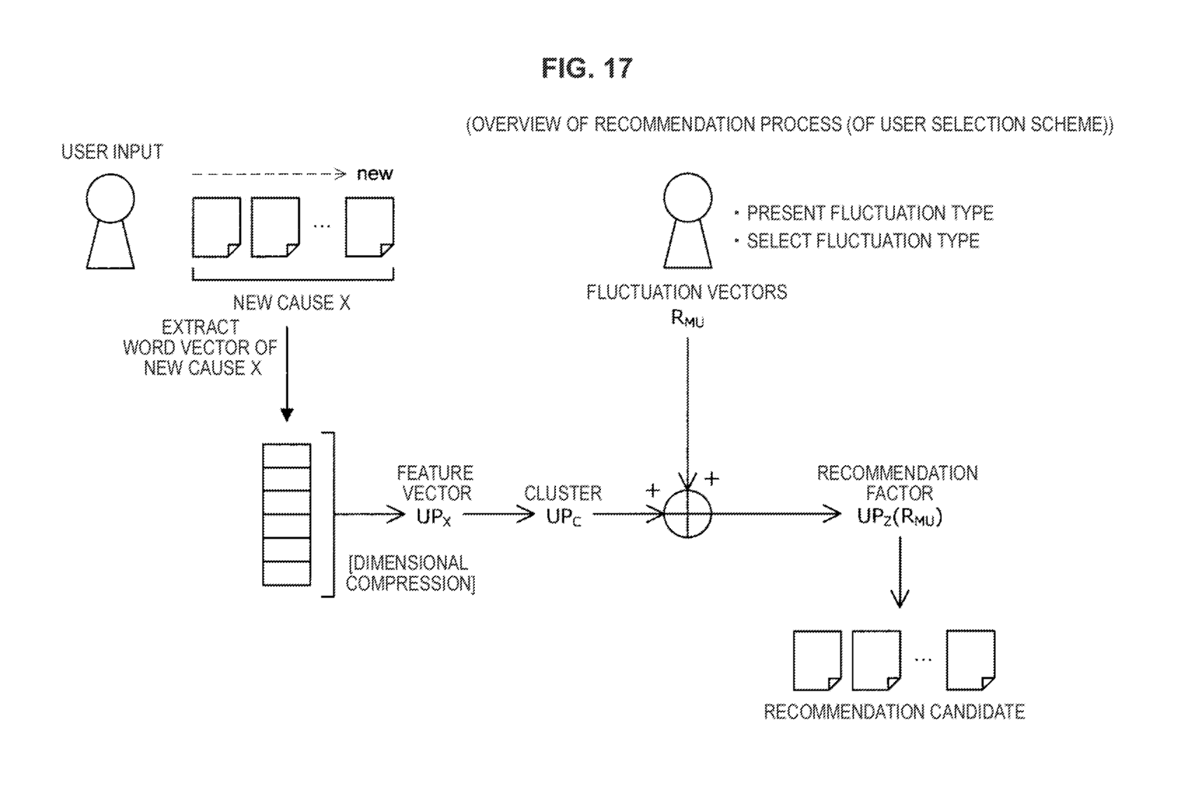

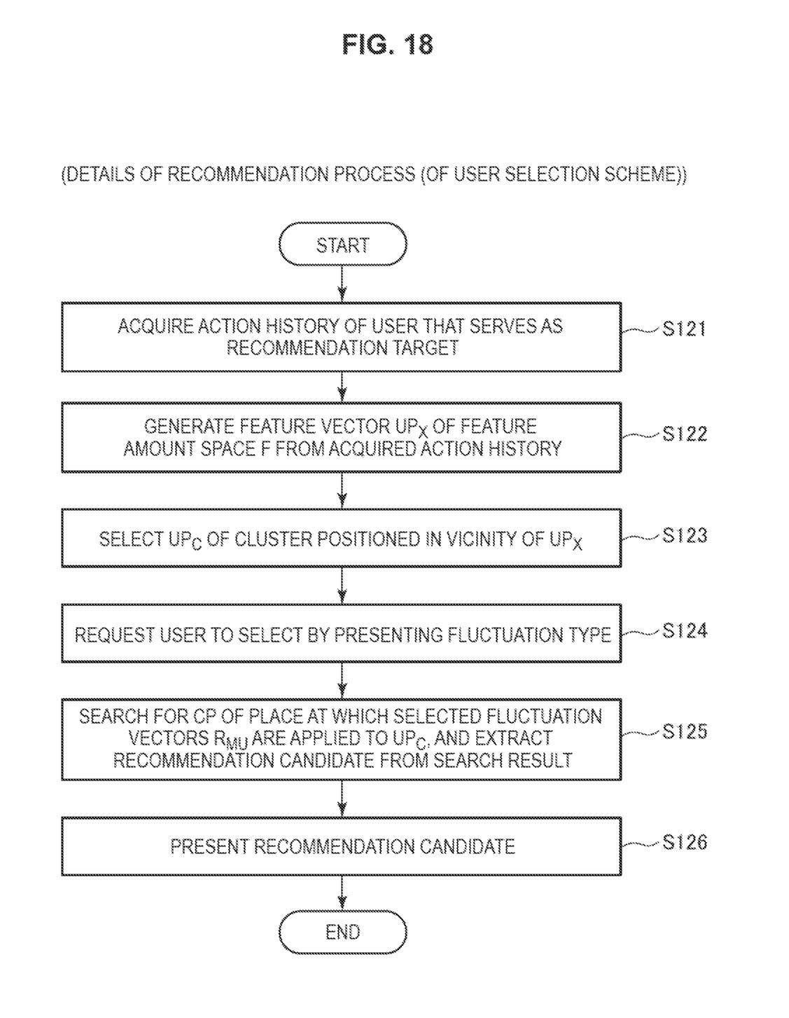

### [2-4: Flow of Recommendation Process (of User Selection Scheme) (FIGS. 17 and 18)]

Description has been provided hitherto on the premise that the change vector R is determined by the recommendation engine 106. However, in eliciting a recommendation result, there may be a case in which a user wants to determine the directivity of a preference change by himself or herself. Hence, a structure in which the change vector R can be selected in the recommendation system 100 (hereinafter, a user selection scheme) will be described below. By having the selectivity, the recommendation system 100 can realize a function as a search system for new relevant information, exceeding the frame of a recommendation system.

### (2-4-1: Overview (FIG. 17))

First, FIG. 17 will be referred to. FIG. 17 is an illustrative diagram for the overview of a recommendation process (of the user selection scheme) according to the present embodiment. Note that the recommendation process to be described below is realized mainly by the function of the recommendation engine 106.

As illustrated in FIG. 17, a new action history (new cause X) of a user is used in the recommendation process. First, the recommendation engine 106 extracts word vectors W characterizing a content group constituting the new cause X. Then, the recommendation engine 106 performs dimensional compression on the extracted word vectors W and then generates a feature vector UPₓ of the feature amount space F. Then, the recommendation engine 106 selects a cluster in the vicinity of the feature vector UPₓ and then obtains a feature vector UP_{c} representing the cluster.

Next, the recommendation engine 106 acquires change vectors R_{M1}, . . . , and R_{Mn} that have undergone merging from the change database 105 and then presents the user with the change types corresponding thereto. When the user selects a change type, the recommendation engine 106 combines a change vector R_{MU} and the feature vector UPc corresponding to the selected change type. Then, the recommendation engine 106 searches for recommendation candidates using a feature vector UP_{z} (R_{MU}) generated in the combining process as a recommendation factor. Then, the recommendation engine 106 presents the user with a predetermined number of results out of the recommendation candidates.

Hereinabove, the overview of the recommendation process (of the user selection scheme) according to the present embodiment has been described.

### (2-4-2: Details (FIG. 18))

Next, the flow of the recommendation process (of the user selection scheme) according to the present embodiment will be described with reference to FIG. 18.

As illustrated in FIG. 18, the recommendation engine 106 first acquires an action history of the user that serves as a recommendation target (S121). Next, the recommendation engine 106 generates the feature vector UPₓ of the feature amount space F from the action history acquired in Step S121 (S122). At this moment, the recommendation engine 106 performs dimensional compression on the word vectors characterizing the action history of the user that serves as a new cause, and then generates the feature vector UPₓ. Then, the recommendation engine 106 selects the feature vector UP_{c} of the cluster positioning in the vicinity of the feature vector UPₓ (S123).

Next, the recommendation engine 106 requests selection from the user after presenting the user with the information of the change types respectively corresponding to the change vectors R_{M1}, . . . , and R_{Mn} (S124; refer to, for example, FIG. 20). Then, the recommendation engine 106 searches for the feature vector CP in the vicinity of the place at which the change vector R_{MU} corresponding to the selected change type is applied to the feature vector UP_{c}, and then extracts the recommendation candidates from the search result (S125). Then, the recommendation engine 106 presents the user with the recommendation candidates (S126). After that, the recommendation engine 106 ends a series of processes relating to the recommendation process.

Hereinabove, the flow of the recommendation process according to the present embodiment has been described.

### [2-5: Display of Recommendation Reason (FIGS. 19 and 20)]

As previously described, when the recommendation result is presented to the user, the recommendation engine 106 presents the user with a reason (recommendation reason) for eliciting the recommendation result. In a case not using the user selection scheme, for example, the recommendation engine 106 is caused to display the recommendation result and the recommendation reason for the change vectors R used to obtain the recommendation result, as illustrated in FIG. 19. In addition, in a case using the user selection scheme, the recommendation engine 106 presents the user with recommendation reasons for each change vector R in the stage in which candidates of the change vector R are extracted, and then allows the user to select a recommendation reason, as illustrated in FIG. 20. Then, the recommendation engine 106 is caused to display the recommendation result using the change vector R corresponding to the selected recommendation reason.

### [2-6: Cross-Category Recommendation (FIG. 21)]

Hitherto, the method for searching for a recommendation factor using the change vector R in the same feature amount space F has been described, but hereinafter, a method for searching for a recommendation factor by projecting the change vector R in a different feature amount space F′ (hereinafter, cross-category recommendation) will be introduced. Cross-category recommendation is appropriate for a case in which, for example, a preference change of a user extracted from an action history relating to eating is applied to recommendation for an action relating to reading.

As described above, an action history of a user is expressed by feature vectors in a feature amount space. For this reason, the feature vectors UP and UPe and the change vector R in a given feature amount space F are obtained from the action history of the user. However, a preference change of a user arising from the course from a cause to a result does not have to be expressed only in the same feature amount space F. For example, if the preference change is “low,” “low” of a “low-priced meal” is expressed in a feature amount space relating to eating, and “low” of a “low call charge” is expressed in the other feature amount space relating to a call charge. In other words, if the targets of “low” relate to each other in different feature amount spaces, the concept of “low” can be projected in the different feature amount spaces.

Specifically, it is better to achieve mapping by preparing a number of feature vectors that are in a corresponding relationship with feature vectors in a given feature amount space F and defined in a different feature amount space F′ and then shifting a point within one feature amount space to a point within the other feature amount space through learning. If the mapping is used, it is possible to convert the change vector R obtained based on a feature vector UP₁ that serves as a cause and a feature vector CP₁ that serves as a result into a change vector R′ in the different feature amount space F′, as illustrated in FIG. 21. Then, by applying the change vector R′ to a new cause UP₂ in the feature amount space F′, a feature vector CP₂ that serves as a recommendation factor is obtained. In other words, by applying the above-described structure to the technique according to the present embodiment, it is possible to appropriately select recommendation candidates that belong to a category using a preference change that belongs to the other category.

Hereinabove, the cross-category recommendation has been described.

Hereinabove, the first embodiment of the present technology has been described. As exemplified herein, the technical idea according to the embodiment of the present technology can be realized using feature vectors.

### 3: Second Embodiment

### Word Vector Base

Next, a second embodiment of the present technology will be described. The present embodiment relates to a recommendation algorithm of a word vector base.

### [3-1: System Configuration (FIG. 22)]

First, a system configuration example of a recommendation system 200 according to the present embodiment will be described with reference to FIG. 22. FIG. 22 is an illustrative diagram for the system configuration example of the recommendation system 200 according to the present embodiment. Note that the recommendation system 200 may be configured by one information processing apparatus having the hardware configuration illustrated in FIG. 27 or some functions thereof, or by a plurality of information processing apparatuses connected to each other via a local or a wide area network or some functions thereof. Of course, the type, communication scheme, or the like constituting the network (for example, LAN, WLAN, WAN, the Internet, a mobile telephone line, a fixed telephone line, ADSL, an optical fiber, GSM, LTE, or the like) can be arbitrarily set.

As illustrated in FIG. 22, the recommendation system 200 is constituted mainly by a user preference extracting engine 201, a feature database 202, a content feature extracting engine 203, a change extracting engine 204, a change database 205, a recommendation engine 206, and a change type database 207. Note that, although not shown in the drawing, the recommendation system 200 has a unit for acquiring information from the external electronic devices 10 and 20. In addition, the electronic devices 10 and 20 may be devices different from each other, or may be the same device.

When a user performs an action, information on the action is input to the user preference extracting engine 201 and the change extracting engine 204 as an action history. Note that, hereinbelow, description will be provided by exemplifying an example of an action of a user selecting content, for the convenience of description. In this case, information of the content (for example, meta data) selected by the user operating the electronic device 10 is input to the user preference extracting engine 201 and the change extracting engine 204 as an action history.

When the action history is input, the user preference extracting engine 201 refers to meta data of the content included in the input action history, and then extracts feature information CP characterizing the content. In the present embodiment, word vectors constituted by word groups characterizing the content are used as the feature information CP.

When the word vectors are generated for each content included in the action history, the user preference extracting engine 201 stores the generated word vectors in the feature database 202. Note that, in the description below, the word vectors generated for each content are denoted by W_{CP}. In addition, the user preference extracting engine 201 collects the word vectors W_{CP} generated for the content included in the action history of each user, and then generates word vectors W_{UP} indicating the preference of each user by superimposing the word vectors W_{CP} thereon. Then, the user preference extracting engine 201 stores the generated word vectors W_{UP} in the feature database 202.

Note that, as a method for generating the word vectors W_{UP}, for example, a method is considered in which a word with a high score is extracted from words constituting a content group included in an action history of a user and then the word is set to be a word vector W_{UP}. In addition, as another method, a method is considered in which word vectors W_{CP} are extracted from each content included in an action history of a user, and then a word vector W_{UP} is generated by combining a word with a high score and the word vectors W_{CP}. In using these methods and other known methods, the word vector W_{UP} characterizing the action history of the user is generated by being directly or indirectly superimposed on the word vectors W_{CP} generated for each user.

The feature database 202 can also store the word vectors W_{CP} of content irrelevant to the action history of the user. Such word vectors W_{CP} are generated by the content feature extracting engine 203. The content feature extracting engine 203 acquires meta data of the content from an external information source, and then generates the word vectors W_{CP} from the acquired meta data. At this moment, the content feature extracting engine 203 generates the word vectors W_{CP} in the same method as that of the user preference extracting engine 201.

In this manner, the feature database 202 stores a number of word vectors W_{CP} and W_{UP} obtained for external content and the content included in the action history of the user. Note that the feature database 202 is appropriately updated according to updating of the action history input to the user preference extracting engine 201 or a change in the external content acquired by the content feature extracting engine 203.

When the feature database 202 is constructed or updated as described above, the change extracting engine 204 extracts a fluctuation component R indicating a preference change of the user arising from the course from a cause to a result, using the word vectors W_{CP} and W_{UP} stored in the feature database 202. In the case of the word vector base, the fluctuation component R is expressed by the difference between the word vector W_{UP} obtained from the action history corresponding to the cause and the word vector W_{CP} (hereinafter, W_{UPe}) obtained from the action history corresponding to the result. Specifically, the fluctuation component R is expressed by a word group (hereinafter, an appearing word group) that is present in the word vector W_{UPe} but not present in the word vector W_{UP} and a word group (hereinafter, a disappearing word group) that is present in the word vector W_{UP} but not present in the word vector W_{UPe}.

First, the change extracting engine 204 divides the action history into combinations (cases) of causes and results in the same manner as in the above-described first embodiment (refer to FIG. 13). Then, the change extracting engine 204 extracts the word vectors W_{UP} and W_{UPe} corresponding to each case from the feature database 202, extracts the difference thereof, and then generates the fluctuation component R. After the fluctuation component R is generated, the change extracting engine 204 stores the generated fluctuation component R in the change database 205. When the feature database 202 and the change database 205 are constructed as described above, content can be recommended using information stored in the databases. The recommendation of the content is realized by the function of the recommendation engine 206.

First, when a recommendation request is received from the user, the recommendation engine 206 starts a recommendation process of content in accordance with the recommendation request. The recommendation request is issued based on a new action of the user. For example, when the user newly selects content by operating the electronic device 20, a recommendation request is sent to the recommendation engine 206 from the electronic device 20. At this moment, the electronic device 20 sends an action history of the user (information indicating the selecting action of new content, or the like) to the recommendation engine 206. When the action history is received, the recommendation engine 206 generates a word vector W_{UP}′ characterizing the user from the word vector W_{CP} characterizing content included in the action history.

At this moment, when the word vector W_{CP} used in the generation of the word vector W_{UP}′ has been stored in the feature database 202, the recommendation engine 206 acquires the corresponding word vector W_{CP} from the feature database 202. On the other hand, when the word vector W_{CP} has not been stored in the feature database 202, the recommendation engine 206 generates the word vector W_{CP} characterizing the content included in the action history received from the electronic device 20 from meta data of the content. Then, the recommendation engine 206 generates the word vector W_{UP}′ by superimposing the word vector W_{CP} thereon. Note that the method for generating the word vector W_{UP}′ is substantially the same as that of the word vector W_{UP} by the user preference extracting engine 201.

When the word vector W_{UP}′ is generated, the recommendation engine 206 generates a set of word vectors W_{CP}″ that serve as recommendation factors using the word vector W_{UP}′ and the change vector R. Specifically, the recommendation engine 206 selects the fluctuation component R, and combines the selected fluctuation component R and the word vector W_{UP}′ so as to set the result as a recommendation factor. The fluctuation component R is stored in the change database 205. The fluctuation component R indicates a preference change of the user arising from the course from the cause to the result.

When there are a number of similar cases, however, it is preferable that the cases be clustered, and then the word vectors W_{UP} and W_{UPe} representing each cluster be selected or the fluctuation component R merged into a word set expressing a change between the clusters. In addition, a cluster corresponding to the word vector W_{UP} may be made to correspond to a plurality of fluctuation components R. Furthermore, each of the fluctuation components R may be set with a score or a weight value. When clustering is used, the recommendation engine 206 selects a cluster close to the word vector W_{UP}′, and then acquires a fluctuation component R corresponding to the cluster. Then, the recommendation engine 206 generates a recommendation factor by combining the word vector W_{UP}′ with the change vector R.

In addition, when the fluctuation component R is selected, the recommendation engine 206 reads information of the change type corresponding to the selected fluctuation component R from the change type database 207, and provides the user with the information of the change type together with a recommendation result. When the fluctuation component R indicates “light,” for example, the change type database 207 stores data (for example, text data, audio data, image data, or the like) indicating “light” corresponding to the fluctuation component R as the information of the change type. For this reason, the recommendation engine 206 provides the user with the data indicating “light” as a recommendation reason together with the recommendation result detected using the recommendation factor based on the fluctuation component R and the word vector W_{UP}′ (for example, refer to FIG. 19). When the user is caused to select the fluctuation component R, the information of the change type may be used as information for identifying selection options (for example, refer to FIG. 20).

Hereinabove, the system configuration of the recommendation system 200 according to the present embodiment has been described. The system configuration described herein is an example, and some structural elements thereof can be appropriately changed in accordance with the embodiment. It is needless to say that such a change also belongs to the technical scope of the present disclosure.

### [3-2: Flow of Learning Process (FIGS. 23 and 24)]

Next, the flow of a learning process according to the present embodiment will be described with reference to FIGS. 23 and 24. Note that the learning process mentioned herein means a process of constructing the feature database 202 and the change database 205.

### (3-2-1: Overview (FIG. 23))

First, FIG. 23 will be referred to. FIG. 23 is an illustrative diagram for the overview of the learning process according to the present embodiment. In addition, note that the procedure illustrated in FIG. 23 is expressed by simplifying the processing order and details in order for the details of the learning process according to the present embodiment to be easily understood. In addition, since the procedure for generating cases is substantially the same as that in the first embodiment described above, description thereof will be omitted herein.

First, when cases #1, . . . , and #m are obtained, a procedure for generating fluctuation components R for each of the cases is executed. For example, when a certain case is considered, one or a plurality of word vectors W_{CP} characterizing a content group constituting a cause A (word set A: W_{UP}) are extracted from the content group. In the same manner, from content constituting a result B, word vectors W_{CP} characterizing the content (word set B: W_{UPe}) are extracted. Then, differences from the word vectors W_{UPe} and the word vectors W_{UP} (a disappearing word group and an appearing word group) are extracted, and then the fluctuation components R are generated. In this way, the fluctuation components R₁, . . . , and Rₘ respectively corresponding to the cases #1, . . . , and #m are generated. The word vectors generated in the above procedure are stored in the feature database 202, and the fluctuation components are stored in the change database 205.

Hereinabove, the overview of the learning process according to the present embodiment has been described. Note that clustering of the cases may be performed at a time at which the fluctuation components R are obtained for the cases #1, . . . , and #m. In this case, the word vectors that have undergone clustering and the fluctuation components that have undergone merging are respectively stored in the feature database 202 and the change database 205.

### (3-2-2: Details (FIG. 24))

Next, FIG. 24 will be referred to. FIG. 24 is an illustrative diagram for the flow of the learning process according to the present embodiment.

As illustrated in FIG. 24, the recommendation system 200 first generates word vectors W characterizing content from meta data of the content (S201). Next, the recommendation system 200 extracts combinations (cases) of “causes and results” from an action history of a user (S202). Then, the recommendation system 200 extracts the differences (a disappearing word group dW and an appearing word group aW) between the word vectors W_{UP} of the “causes” and the word vectors W_{UPe} of the “results” for all of the combinations of the “causes and results,” and then generates the fluctuation components R (S203). Then, the recommendation system 200 stores the word vectors W_{CP} and the word vectors W_{UP} that have undergone clustering in the feature database 202, and stores the fluctuation components R that have undergone merging in the change database 205 (S204). After that, the recommendation system 200 ends a series of processes relating to the learning process.

Hereinabove, the flow of the learning process according to the present embodiment has been described. In the example of FIG. 24, a case in which a clustering process and a merging process are not performed has been described, but the flow of a process can also be modified in consideration of a clustering process for the word vectors and a merging process for the fluctuation components.

### [3-3: Flow of Recommendation Process (FIGS. 25 and 26)]

Next, the flow of a recommendation process according to the present embodiment will be described with reference to FIGS. 25 and 26.

### (3-3-1: Overview (FIG. 25))

As illustrated in FIG. 25, in the recommendation process, a new action history (new cause C) of the user is used. First, the recommendation engine 206 extracts one or a plurality of word vectors WC characterizing a content group constituting the new cause C (word set C). Next, the recommendation engine 206 selects the fluctuation components R stored in the change database 105, and then generates recommendation factors by applying the selected fluctuation components R to the word set C. Specifically, the recommendation factors (word set D) are generated by deleting a disappearing word group from the word set C and then adding an appearing word group thereto. Next, the recommendation engine 206 searches for recommendation candidates using the generated recommendation factors. Then, the recommendation engine 206 presents the user with a predetermined number of recommendation results among the recommendation candidates. At this moment, the recommendation engine 206 presents the user with information on change types (recommendation reason) together with the recommendation results.

Hereinabove, the overview of the recommendation process according to the present embodiment has been described. Note that, in the above description, the expression “word group” is used, but a word vector is also an example of a word set. In addition, a word vector group constituted by a plurality of word vectors is also an example of a word set.

### (3-3-2: Details (FIG. 26))

Next, the flow of the recommendation process according to the present embodiment will be described with reference to FIG. 26.

As illustrated in FIG. 26, the recommendation engine 206 acquires, as a new cause, an action history of the user that serves as a recommendation target (S211). Next, the recommendation engine 206 generates a word vector W_{UP}′ characterizing the action history acquired in Step S211 (S212). Then, the recommendation engine 206 generates a word vector W_{UPe}′ by applying the change vectors R (the disappearing word group dW and the appearing word group aW) to the word vector W_{UP}′, and then extracts recommendation candidates using the word vector W_{UPe}′ (S214). Then, the recommendation engine 206 presents the user with the recommendation candidates corresponding to the fluctuation components R together with a recommendation reason (S215). After that, the recommendation engine 206 ends a series of processes relating to the recommendation process.

Hereinabove, the flow of the recommendation process according to the present embodiment has been described.

[3-4: Combination with Feature Vector Base]

Hitherto, the example of the word vector base has been described. In addition, the example of the feature vector base has already been described. The examples can be individually used, but can also be used in combination of both. When content including image data and text data is set as the target of an action, for example, a combination technique is considered in which the structure of the feature vector base is applied to the image data and the structure of the word vector base is applied to the text data. In addition, the same is applied to a case in which content including audio data or other binary data instead of image data is set as the target of an action.

In addition, a combining technique is considered in which both recommendation candidates extracted in the structure of the feature vector base and in the structure of the word vector base are presented to a user. Furthermore, a structure may be used in which scores of the recommendation candidates extracted by the combining technique are computed and a predetermined number of recommendation candidates with scores in a descending order are presented to the user. In this manner, the structures of the feature vector base and the word vector base can be combined. In addition, such a combination also belongs to the technical scope of the embodiments according to the present technology.

Hereinabove, the combining technique of the structures of the feature vector base and the word vector base has been described.

Hereinabove, the second embodiment according to the present technology has been described. As exemplified herein, it is possible to realize the technical idea according to the embodiments of the present technology using a word vector. In addition, it is possible for the structure to be combined with the structure of the feature vector base.

### 4: Regarding Applicability

Hitherto, the description has been provided on the condition of digital content including text data, for the convenience of the description. However, the technical scope according to the embodiments of the present technology can also be applied to action targets other than digital content including text data. In the case of music data, for example, if a feature amount is extracted from the waveform thereof, or the like, the structure of the feature vector base can be applied thereto. In addition, in the case of image data, if a feature amount is extracted from color, edge information thereof, or the like, the structure of the feature vector base can be applied thereto. In the case of moving image data, if a feature amount is extracted from the color or edge information of each frame, intra-frame encoding information, inter-frame encoding information, scene information, chapter information, or the like, the structure of the feature vector base can be applied thereto.

In addition, in the case of music data, meta data including names of artists, biographies, genres, sales, ratings, mood information, and the like may be imparted thereto. Based on this, since word vectors can be extracted from the meta data, the structures of the feature vector base and the word vector base can be applied thereto. In a similar manner, in the case of image data, meta data including persons, places, objects, times, photographing conditions (for example, the F value, the zoom value, the use of flash, and the like), and the like may be imparted thereto. Based on this, since word vectors can be extracted from the meta data, the structures of the feature vector base and the word vector base can be applied thereto.

In addition, in the case of moving image data, meta data including the acting cast, genres, reviews of users, and the like may be imparted thereto. In addition, in the case of movies, television videos, and the like, meta data including sponsor names, preview information, and the like may be obtained. Based on this, since word vectors can be extracted from the meta data, the structures of the feature vector base and the word vector base can be applied thereto. Note that, in the case of sentences included in books, diaries, home pages, research papers, and the like, meta data including publishing dates, categories, genres, publishers' information, authors' information, and the like may be imparted thereto. Based on this, since word vectors can be extracted from the meta data, the structures of the feature vector base and the word vector base can be applied thereto.

In addition to that, as an action history of a user, for example, a movement trace using the GPS function, a purchase or rental history obtained using a POS system, or the like, a call history, an e-mail transmission and reception history, an operation history of a music player, an access history to a home page, or the like can be used. Furthermore, it is also possible to obtain a use history of home appliances from the home electric power use state, or the like, to obtain a driving history of a vehicle, a motorcycle, or the like, or to obtain ticketing information of a public transportation service so that the history can be used as an action history for recommendation. In addition, content to be recommended is not limited to digital content, and an arbitrary target including various goods and services can be recommended. In this way, the technical idea according to the embodiments of the present technology has a wide range of applicability.

Hereinabove, the applicability of the technical idea according to the embodiments of the present technology has been described. It is of course needless to say that the applicability is not limited to the above-described examples.

### 5: Hardware Configuration Example (FIG. 27)

The functions of each of the structural elements constituting the above-described recommendation systems 100 and 200 can be realized using a hardware configuration of an information processing apparatus illustrated in, for example, FIG. 27. In other words, the functions of each of the structural elements are realized by controlling the hardware illustrated in FIG. 27 using a computer program. Note that the form of the hardware is arbitrary, and, for example, mobile information terminals including a personal computer, a mobile telephone, a PHS, a PDA, and the like, game devices, and various kinds of information appliances are included therein. Moreover, “PHS” above is an abbreviation for Personal Handy-phone System. In addition, “PDA” above is an abbreviation for Personal Digital Assistant.

As shown in FIG. 27, this hardware mainly includes a CPU 902, a ROM 904, a RAM 906, a host bus 908, and a bridge 910. Furthermore, this hardware includes an external bus 912, an interface 914, an input unit 916, an output unit 918, a storage unit 920, a drive 922, a connection port 924, and a communication unit 926. Moreover, the CPU is an abbreviation for Central Processing Unit. Also, the ROM is an abbreviation for Read Only Memory. Furthermore, the RAM is an abbreviation for Random Access Memory.

The CPU 902 functions as an arithmetic processing unit or a control unit, for example, and controls entire operation or a part of the operation of each structural element based on various programs recorded on the ROM 904, the RAM 906, the storage unit 920, or a removal recording medium 928. The ROM 904 is means for storing, for example, a program to be loaded on the CPU 902 or data or the like used in an arithmetic operation. The RAM 906 temporarily or perpetually stores, for example, a program to be loaded on the CPU 902 or various parameters or the like arbitrarily changed in execution of the program.

These structural elements are connected to each other by, for example, the host bus 908 capable of performing high-speed data transmission. For its part, the host bus 908 is connected through the bridge 910 to the external bus 912 whose data transmission speed is relatively low, for example. Furthermore, the input unit 916 is, for example, a mouse, a keyboard, a touch panel, a button, a switch, or a lever. Also, the input unit 916 may be a remote control that can transmit a control signal by using an infrared ray or other radio waves.

The output unit 918 is, for example, a display device such as a CRT, an LCD, a PDP or an ELD, an audio output device such as a speaker or headphones, a printer, a mobile phone, or a facsimile, that can visually or auditorily notify a user of acquired information. Moreover, the CRT is an abbreviation for Cathode Ray Tube. The LCD is an abbreviation for Liquid Crystal Display. The PDP is an abbreviation for Plasma Display Panel. Also, the ELD is an abbreviation for Electro-Luminescence Display.

The storage unit 920 is a device for storing various data. The storage unit 920 is, for example, a magnetic storage device such as a hard disk drive (HDD), a semiconductor storage device, an optical storage device, or a magneto-optical storage device. The HDD is an abbreviation for Hard Disk Drive.

The drive 922 is a device that reads information recorded on the removal recording medium 928 such as a magnetic disk, an optical disk, a magneto-optical disk, or a semiconductor memory, or writes information in the removal recording medium 928. The removal recording medium 928 is, for example, a DVD medium, a Blu-ray medium, an HD-DVD medium, various types of semiconductor storage media, or the like. Of course, the removal recording medium 928 may be, for example, an electronic device or an IC card on which a non-contact IC chip is mounted. The IC is an abbreviation for Integrated Circuit.

The connection port 924 is a port such as an USB port, an IEEE1394 port, a SCSI, an RS-232C port, or a port for connecting an externally connected device 930 such as an optical audio terminal. The externally connected device 930 is, for example, a printer, a mobile music player, a digital camera, a digital video camera, or an IC recorder. Moreover, the USB is an abbreviation for Universal Serial Bus. Also, the SCSI is an abbreviation for Small Computer System Interface.

The communication unit 926 is a communication device to be connected to a network 932, and is, for example, a communication card for a wired or wireless LAN, Bluetooth (registered trademark), or WUSB, an optical communication router, an ADSL router, or a modem for various communications. The network 932 connected to the communication unit 926 is configured from a wire-connected or wirelessly connected network, and is the Internet, a home-use LAN, infrared communication, visible light communication, broadcasting, or satellite communication, for example. Moreover, the LAN is an abbreviation for Local Area Network. Also, the WUSB is an abbreviation for Wireless USB. Furthermore, the ADSL is an abbreviation for Asymmetric Digital Subscriber Line.

### 6: Summary

Finally, the technical idea of the present embodiment will be briefly summarized. The technical idea described below can be applied to various information processing apparatuses such as a PC, a mobile telephone, a game device, an information terminal, an information appliance, a car navigation system, an imaging device, an image recording and reproducing device, a video receiver, a video display device, a set-top box, and a communication device.

The functional configuration of the information processing apparatus described above can be expressed, for example, as below. The information processing apparatus to be described in (1) below includes a configuration in which difference feature information indicating the difference between first feature information corresponding to a cause and second feature information corresponding to a result is used in extraction of information. In addition, the information processing apparatus includes a configuration in which fourth feature information to be used in extraction of information is obtained using the difference feature information and third feature information corresponding to a new cause. A preference change of a user is taken into consideration using the difference feature information. On the other hand, since the third feature information is used in the extraction of information, fixed preference of the user is taken into consideration. As a result, the preference change and fixed preference of the user are taken into consideration in the information extracted by the information processing apparatus to be described in (1) below. In other words, it is possible to provide the user with information that gives the user a sense of novelty while the intrinsic taste of the user is considered. Note that, since the information processing apparatus to be described in (1) below expresses the preference change of the user by a difference of feature information, suitable information as described above can be obtained through a process with a relatively light load.

(1) An information processing apparatus comprising:

a difference applying unit that obtains, according to difference feature information indicating a difference between first feature information characterizing an action of a target user and second feature information characterizing another action performed by the target user after the foregoing action is performed and third feature information characterizing an action newly performed by the target user, fourth feature information; and

a target extracting unit that extracts information based on the fourth feature information.

(2) The information processing apparatus according to (1),

wherein the first feature information is one or a plurality of pieces of content selected by the target user, and

the second feature information is content selected by the target user after the target user selects one or the plurality of pieces of content.

(3) The information processing apparatus according to (1) or (2), wherein the difference applying unit obtains the fourth feature information by causing the difference feature information to affect the third feature information.

(4) The information processing apparatus according to (2) or (3),

wherein the first feature information is expressed by a first feature vector,

the second feature information is expressed by a second feature vector,

the difference feature information is expressed by a difference feature vector indicating a difference between the first feature vector and the second feature vector in a feature amount space,

the third feature information is expressed by a third feature vector, and

the difference applying unit obtains, as the fourth feature information, a fourth feature vector by combining the third feature vector and the difference feature vector.

(5) The information processing apparatus according to (4),

wherein the first feature vector is obtained based on a first word vector constituted by a characteristic word group extracted from one or a plurality of pieces of content selected by the target user, and

the second feature vector is obtained based on a second word vector constituted by a characteristic word group extracted from content selected by the target user after the one or the plurality of pieces of content are selected.

(6) The information processing apparatus according to (5),

wherein the first feature vector is obtained by performing dimensional compression on the first word vector constituted by the characteristic word group extracted from the one or the plurality of pieces of content selected by the target user, and

the second feature vector is obtained by mapping, to a feature amount space regulating the first feature vector, the second word vector constituted by the characteristic word group extracted from the content selected by the target user after the one or the plurality of pieces of content are selected.

(7) The information processing apparatus according to (5) or (6),

wherein each word constituting the first word vector is set with a weight value according to the degree of significance of the word, and the weight value is considered when the first feature vector is obtained, and

each word constituting the second word vector is set with a weight value according to the degree of significance of the word, and the weight value is considered when the second feature vector is obtained.

(8) The information processing apparatus according to (3), wherein the difference applying unit obtains the fourth feature information by imparting a predetermined weight to the difference feature information and then causing the difference feature information to affect the third feature information.

(9) The information processing apparatus according to any one of (1) to (3),

wherein the first feature information is a first word vector constituted by a characteristic word group extracted from one or a plurality of pieces of content selected by the target user,

the second feature information is a second word vector constituted by a characteristic word group extracted from pieces of content selected by the target user after the one or the plurality of pieces of content are selected, and

the difference feature information is constituted by a disappearing word vector constituted by a word group that is included in the first word vector but not included in the second word vector and an appearing word vector constituted by a word group that is included in the second word vector but not included in the first word vector.

(10) The information processing apparatus according to (9),

wherein the third feature information is a third word vector constituted by a characteristic word group extracted from pieces of content newly selected by the target user, and

the difference applying unit deletes a word included in the disappearing word vector from the third word vector when the word included in the disappearing word vector is included in the third word vector, and obtains the fourth feature information by adding a word included in the appearing word vector to the third word vector when there is a word that is included in the appearing word vector but not in the third word vector.

(11) The information processing apparatus according to any one of (4) to (8), further comprising:

a difference mapping unit that maps the difference feature vector obtained in a first feature amount space to a second feature amount space using mapping information that causes points within both feature amount spaces to be associated with each other over the first and the second feature amount spaces that belong to different categories,

wherein the difference applying unit obtains the fourth feature vector by combining the third feature vector characterizing pieces of content newly selected by the target user in the category to which the second feature amount space belongs and the difference feature vector mapped to the second feature amount space.

(12) The information processing apparatus according to any one of (1) to (11), wherein the difference applying unit selects feature information having a feature close to that of the third feature information from a plurality of pieces of feature information characterizing an action of a user, and then obtains the fourth feature information using difference feature information corresponding to the selected feature information.

(13) The information processing apparatus according to any one of (1) to (11), wherein the difference applying unit selects a cluster having a feature close to that of the third feature information from a plurality of clusters obtained by clustering a plurality of pieces of feature information characterizing an action of a user, and then obtains the fourth feature information using difference feature information corresponding to feature information representing the selected cluster.

(14) The information processing apparatus according to any one of (1) to (11), further comprising:

an information providing unit that provides a user with information,

wherein the difference applying unit selects feature information having a feature close to the third feature information from a plurality of pieces of feature information characterizing an action of the user,

the information providing unit provides the user with difference feature information corresponding to the feature information that the difference applying unit selects so as to promote selection of the difference feature information, and

the difference applying unit obtains the fourth feature information using the difference feature information selected by the user.

(15) The information processing apparatus according to any one of (1) to (11), further comprising:

an information providing unit that provides a user with information,

wherein the difference applying unit selects a cluster having a feature close to that of the third feature information from a plurality of clusters obtained by clustering a plurality of pieces of feature information characterizing an action of the user,

the information providing unit provides the user with difference feature information corresponding to feature information representing a cluster that the difference applying unit selects so as to promote selection of the difference feature information, and

the difference applying unit obtains the fourth feature information using the difference feature information selected by the user.

(16) An information processing method comprising:

obtaining, according to difference feature information indicating a difference between first feature information characterizing an action of a target user and second feature information characterizing another action performed by the target user after the foregoing action is performed and third feature information characterizing an action newly performed by the target user, fourth feature information; and

extracting information based on the fourth feature information.

(17) A program that causes a computer to realize:

a difference applying function for obtaining, according to difference feature information indicating a difference between first feature information characterizing an action of a target user and second feature information characterizing another action performed by the target user after the foregoing action is performed and third feature information characterizing an action newly performed by the target user, fourth feature information; and

a target extraction function for extracting information based on the fourth feature information.

(18) A computer-readable recording medium having recorded thereon a program that causes a computer to realize:

a difference applying function for obtaining, according to difference feature information indicating a difference between first feature information characterizing an action of a target user and second feature information characterizing another action performed by the target user after the foregoing action is performed and third feature information characterizing an action newly performed by the target user, fourth feature information; and

a target extraction function for extracting information based on the fourth feature information.

### (Reference)

The recommendation engines 106 and 206 described above are an example of a difference applying unit, a target extracting unit, a difference mapping unit, or an information providing unit.

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

It should be understood by those skilled in the art that various modifications, combinations, sub-combinations and alterations may occur depending on design requirements and other factors insofar as they are within the scope of the appended claims or the equivalents thereof.

The present technology contains subject matter related to that disclosed in Japanese Priority Patent Application JP 2011-248604 filed in the Japan Patent Office on Nov. 14, 2011, the entire content of which is hereby incorporated by reference.

What is claimed is:

1. An information processing apparatus comprising:
a difference applying unit that obtains, according to difference feature information indicating a difference between first feature information characterizing an action of a target user and second feature information characterizing another action performed by the target user after the foregoing action is performed and third feature information characterizing an action newly performed by the target user, fourth feature information; and
a target extracting unit that extracts information based on the fourth feature information.

2. The information processing apparatus according to claim 1,
wherein the first feature information is one or a plurality of pieces of content selected by the target user, and
the second feature information is content selected by the target user after the target user selects one or the plurality of pieces of content.

3. The information processing apparatus according to claim 1, wherein the difference applying unit obtains the fourth feature information by causing the difference feature information to affect the third feature information.

4. The information processing apparatus according to claim 2,
wherein the first feature information is expressed by a first feature vector,
the second feature information is expressed by a second feature vector,
the difference feature information is expressed by a difference feature vector indicating a difference between the first feature vector and the second feature vector in a feature amount space,
the third feature information is expressed by a third feature vector, and
the difference applying unit obtains, as the fourth feature information, a fourth feature vector by combining the third feature vector and the difference feature vector.

5. The information processing apparatus according to claim 4,
wherein the first feature vector is obtained based on a first word vector constituted by a characteristic word group extracted from one or a plurality of pieces of content selected by the target user, and
the second feature vector is obtained based on a second word vector constituted by a characteristic word group extracted from content selected by the target user after the one or the plurality of pieces of content are selected.

6. The information processing apparatus according to claim 5,
wherein the first feature vector is obtained by performing dimensional compression on the first word vector constituted by the characteristic word group extracted from the one or the plurality of pieces of content selected by the target user, and
the second feature vector is obtained by mapping, to a feature amount space regulating the first feature vector, the second word vector constituted by the characteristic word group extracted from the content selected by the target user after the one or the plurality of pieces of content are selected.

7. The information processing apparatus according to claim 5,
wherein each word constituting the first word vector is set with a weight value according to the degree of significance of the word, and the weight value is considered when the first feature vector is obtained, and
each word constituting the second word vector is set with a weight value according to the degree of significance of the word, and the weight value is considered when the second feature vector is obtained.

8. The information processing apparatus according to claim 3, wherein the difference applying unit obtains the fourth feature information by imparting a predetermined weight to the difference feature information and then causing the difference feature information to affect the third feature information.

9. The information processing apparatus according to claim 1,
wherein the first feature information is a first word vector constituted by a characteristic word group extracted from one or a plurality of pieces of content selected by the target user,
the second feature information is a second word vector constituted by a characteristic word group extracted from pieces of content selected by the target user after the one or the plurality of pieces of content are selected, and
the difference feature information is constituted by a disappearing word vector constituted by a word group that is included in the first word vector but not included in the second word vector and an appearing word vector constituted by a word group that is included in the second word vector but not included in the first word vector.

10. The information processing apparatus according to claim 9,
wherein the third feature information is a third word vector constituted by a characteristic word group extracted from pieces of content newly selected by the target user, and
the difference applying unit deletes a word included in the disappearing word vector from the third word vector when the word included in the disappearing word vector is included in the third word vector, and obtains the fourth feature information by adding a word included in the appearing word vector to the third word vector when there is a word that is included in the appearing word vector but not in the third word vector.

11. The information processing apparatus according to claim 4, further comprising:
a difference mapping unit that maps the difference feature vector obtained in a first feature amount space to a second feature amount space using mapping information that causes points within both feature amount spaces to be associated with each other over the first and the second feature amount spaces that belong to different categories,
wherein the difference applying unit obtains the fourth feature vector by combining the third feature vector characterizing pieces of content newly selected by the target user in the category to which the second feature amount space belongs and the difference feature vector mapped to the second feature amount space.

12. The information processing apparatus according to claim 1, wherein the difference applying unit selects feature information having a feature close to that of the third feature information from a plurality of pieces of feature information characterizing an action of a user, and then obtains the fourth feature information using difference feature information corresponding to the selected feature information.

13. The information processing apparatus according to claim 1, wherein the difference applying unit selects a cluster having a feature close to that of the third feature information from a plurality of clusters obtained by clustering a plurality of pieces of feature information characterizing an action of a user, and then obtains the fourth feature information using difference feature information corresponding to feature information representing the selected cluster.

14. The information processing apparatus according to claim 1, further comprising:
an information providing unit that provides a user with information,
wherein the difference applying unit selects feature information having a feature close to the third feature information from a plurality of pieces of feature information characterizing an action of the user,
the information providing unit provides the user with difference feature information corresponding to the feature information that the difference applying unit selects so as to promote selection of the difference feature information, and
the difference applying unit obtains the fourth feature information using the difference feature information selected by the user.

15. The information processing apparatus according to claim 1, further comprising:
an information providing unit that provides a user with information,
wherein the difference applying unit selects a cluster having a feature close to that of the third feature information from a plurality of clusters obtained by clustering a plurality of pieces of feature information characterizing an action of the user,
the information providing unit provides the user with difference feature information corresponding to feature information representing a cluster that the difference applying unit selects so as to promote selection of the difference feature information, and
the difference applying unit obtains the fourth feature information using the difference feature information selected by the user.

16. An information processing method comprising:
obtaining, according to difference feature information indicating a difference between first feature information characterizing an action of a target user and second feature information characterizing another action performed by the target user after the foregoing action is performed and third feature information characterizing an action newly performed by the target user, fourth feature information; and
extracting information based on the fourth feature information.

17. A program that causes a computer to realize:
a difference applying function for obtaining, according to difference feature information indicating a difference between first feature information characterizing an action of a target user and second feature information characterizing another action performed by the target user after the foregoing action is performed and third feature information characterizing an action newly performed by the target user, fourth feature information; and
a target extraction function for extracting information based on the fourth feature information.
